(19) United States
(12) Patent Application Publication
(10) Pub. No.: US 2006/0265436 A1
(43) Pub. Date: Nov. 23, 2006

(54) GRID NETWORK FOR DISTRIBUTION OF FILES

(76) Inventors: ANDREW EDMOND, VASHON, WA (US); STEVEN OHMERT, VASHON, WA (US)

Correspondence Address: PERKINS COIE LLP, P.O. BOX 2168, MENLO PARK, CA, 94026, US

(21) Appl. No.: 11/419,484

(22) Filed: May 19, 2006

Related U.S. Application Data
(60) Provisional application No. 60/683,129, filed on May 20, 2005.

(51) Int. Cl. G06F 17/30; G06F 12/00

(52) U.S. Cl. 707/204

(57) ABSTRACT

In an embodiment, a system is provided. The system includes a server. The server has a network interface, a local repository interface, and a control module. The server further includes a local repository. The server is to interact with clients of a grid network. The server is further to receive status updates from clients of the grid network. In another embodiment, a method is provided. The method includes receiving a request to seed a data file. Also, the method includes selecting clients of a grid network to receive the data file based on network connectivity. Further, the method includes sending segments of the data file to selected clients of the grid network responsive to the request to seed the data file.

### CROSS-REFERENCE TO RELATED APPLICATION

This application claims priority to U.S. Provisional Patent Application No. 60/683,129, filed on May 20, 2005, which is hereby incorporated herein by reference.

### BACKGROUND

Media owners herein defined as those that have proprietary rights in media content such as movies, television, software, books, and music, have not yet found a technology system capable of using the full potential of the Internet to broadcast their media securely, at a low cost, with high quality and with effective monetization rules. There continues to be a need for an “end to end system” (i.e. deliverer to consumer) to manage a network of potentially thousands of media owners and millions of users in a low cost, delivery network with effective monetization rules and high security.

Currently, many media owners are “direct streaming” movie files and audio files from a website or a streaming server via the Internet to end users. These files, especially video files, are very large by the nature of the complexity of their data. This kind of direct streaming is relatively expensive for both hardware and bandwidth costs. Further, mass streaming, for example direct streaming to one million users at once, requires not only extensively powerful clusters of enterprise hardware, but also one million times the bandwidth cost of streaming a single movie.

In addition, media owners that partner with other “outlets” (e.g. web portals, online merchants, etc.) to provide media content to end users often expend negotiation effort and money on each syndication deal, which poses an obstacle to profitable syndication. If media owners had access to an easy to configure, control, and manage syndication system, and outlet partners might more easily consume and configure that syndication, media could be more readily distributed, and the media owner would control monetization.

Other challenges relate to media encoding and end user playing. Encoding of media from original sources or copies is labor and equipment intensive, leading to high costs. In addition, movie and audio player technologies are often developed and controlled by business entities that have an interest in selling other software, such as an operating system for example, along with their player technology. Accordingly, there is a need for a media player that is independent of operating system platform and is designed to work on any operating system (or require no operating system), so that it can be used in personal computers, set top boxes, gaming consoles, embedded systems, and cell phones.

### BRIEF DESCRIPTION OF THE DRAWINGS

The present invention is illustrated by way of example in the accompanying drawings. The drawings should be understood as illustrative rather than limiting.

FIG. 1 provides an illustration of an embodiment of a grid network.

FIG. 2 provides an illustration of an embodiment of a media vault.

FIG. 3 provides an illustration of an embodiment of a codec.

FIG. 4 provides an illustration of an embodiment of syndication feeds.

FIG. 5 provides an illustration of an embodiment of a geo-located super node.

FIG. 6 provides an illustration of an embodiment of an encoding studio.

FIG. 7 provides an illustration of an embodiment of a media player.

FIG. 8 provides an illustration of an embodiment of a client.

FIG. 9 provides an illustration of an embodiment of a super node protocol.

FIG. 10 provides an illustration of an embodiment of a process for playing a movie file from a grid network.

FIG. 11 provides an illustration of an embodiment of a grid system.

FIG. 12 provides an illustration of an embodiment of a packet used in response to a request for a data file.

FIG. 13 provides an illustration of an embodiment of a job ticket.

FIG. 14 provides an illustration of an embodiment of a process of encrypting a media file.

FIG. 15 provides an illustration of an embodiment of a process of using an encrypted media file.

FIG. 16 provides an illustration of an embodiment of a media file.

FIG. 17A provides an illustration of an embodiment of a segment of a media file.

FIG. 17B provides an illustration of an embodiment of a hash value of a media file.

FIG. 18 provides an illustration of an embodiment of a grid network.

FIG. 19 provides an illustration of an embodiment of a process of requesting a media file.

FIG. 20A provides an illustration of an embodiment of a process of assisting a request for a media file.

FIG. 20B provides an illustration of an embodiment of a grid network in which a private client assists a public client.

FIG. 21 provides an illustration of a set of files in an embodiment.

FIG. 22 provides an illustration of a process of providing a file in a desired format in an embodiment.

FIG. 23 provides an illustration of an embodiment of a system in which a file is being shared.

FIG. 24 provides an illustration of an embodiment of a process of receiving a file stream in an embodiment.

FIG. 25 provides an illustration of an embodiment of a representation of urgency.

FIG. 26 provides an illustration of an embodiment of a grid network.

FIG. 27 provides an illustration of an embodiment of encryption protection.

FIG. 28 provides an illustration of an embodiment of a client in an embodiment of a grid network.

FIG. 29 provides an illustration of another embodiment of a grid network.

FIG. 30 provides an illustration of an embodiment of a method of seeding a grid network.

FIG. 31 provides an illustration of an embodiment of a seeded grid network.

FIG. 32 provides an illustration of an embodiment of a network which may be used to implement a grid network.

FIG. 33 provides an illustration of an embodiment of a machine which may be used in a grid network.

FIG. 34 provides an illustration of an embodiment of a client in an embodiment of a network.

FIG. 35 provides an illustration of an embodiment of a server in an embodiment of a network.

### DETAILED DESCRIPTION

A system, method and apparatus is provided for a grid network for distribution of files. The specific embodiments described in this document represent example instances of the present invention, and are illustrative in nature rather than restrictive. Various embodiments provide a system for end to end production, use-rights, digital rights, encoding, compression, content management, monetized syndication, grid network delivery, and portable player technology. Other embodiments may provide a subset of these functions, and may provide other functions as well. Digital media delivery is potentially made affordable by forming and making nodes from every player application distributed (essentially every client) that are able to receive and resend segments of digital media. Syndicated content feeds may allow content providers to easily sell entire libraries of digital data to distribution partners. Some embodiments also provide the encoding and compression of digital movies, and client technology to manage the downloading and sharing of encrypted media files. Digital rights management may be embedded into all layers of such an end to end platform.

In an embodiment, a system is provided. The system includes first server nodes having authentication functions coupled to a network. The system also includes second server nodes having repositories of complete files also coupled to the network. The system further includes a set of client nodes having local repositories for files coupled to the network. The client nodes are configured to share segments of complete files on a peer-to-peer basis through the network.

In another embodiment, a method is provided. The method includes requesting segments of a media file from a first client through a peer-to-peer connection. The method further includes providing a first authenticated job ticket in the requesting. The method also includes receiving the segments of the media file from the first client through a peer-to-peer connection so long as the first authenticated job ticket remains valid.

In yet another embodiment, a system is provided. The system includes a local client. The local client includes a network interface, a repository interface, a rendering interface, an encryption engine, a user interface, and a control module. The system also includes a local repository. The local client is to interact with a server on a network through the network interface to receive authorization for file access. The local client is also to transfer segments of a file to and from the local repository and to and from other local clients on other systems using authenticated peer-to-peer connections.

In another embodiment, a method is provided. The method includes receiving an invitation to request segments from a first client in a grid network. The first client is coupled to the grid network through a firewall. The method also includes responding to the invitation to request segments with a request for segments. The method further includes receiving segments from the first client responsive to the request for segments.

In yet another embodiment, a method is provided. The method includes receiving information about a first client from a server in a grid network at a second client. The second client is coupled to the grid network through a firewall. The method further includes sending an invitation to request segments to the first client. The method also includes receiving a request for segments from the first client.

In a further embodiment, a system is provided. The system includes a server. The server has a network interface, a local repository interface, and a control module. The server further includes a local repository. The server is to interact with clients of a grid network. The server is further to receive status updates from clients of the grid network.

In another embodiment, a method is provided. The method includes receiving a request to seed a data file. Also, the method includes selecting clients of a grid network to receive the data file based on network connectivity. Further, the method includes sending segments of the data file to selected clients of the grid network responsive to the request to seed the data file.

In still another embodiment, a method is provided. The method includes receiving a data file. The method further includes determining a hash value of the data file. The method also includes determining segmentation of the data file. The method additionally includes encrypting segments of the data file.

In another embodiment, a method is provided. The method includes receiving a segment of a data file. The method also includes decrypting the segment of the data file. The method further includes rendering the decrypted segment of the data file.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Embodiments may solve many of the problems identified above and provide a system and components that meet many, if not all, of the identified needs. Further, the system may present all of these components in a single unified platform that any media owner can use, any outlet partner can consume, and any end user can view and watch wherever desired. Thus, various embodiments provide an end to end platform for encoding, encrypting, establishing use-rights and digital rights, content management, monetized syndication, high speed “on-demand” grid network delivery, and portable media player technology. For the purposes of this document, digital video will be used as an illustrative example of the inventive system, though it should be understood that the invention is not limited to this example. In various embodiments, digital music, books, software, computer games, and other media may also be circulated or provided.

For video encoding, the system of some embodiments uses an automated “harness” which allows a technician to “load” media using DVD media, film media, and analog media (such as VHS tapes) into a storage system. Automated encoding computers, when idle, read a directory on the storage system looking for new media to acquire and begin encoding. When the encoding computer has a full copy of a new media file, it will proceed to encode it into a desired video and audio codec, and produce a set of new media files at varied bit rates in a two pass encoding system. After the media is encoded, it is then stored on an external “shipping” storage array ready to be delivered to the customer.

The digital media vault system of some embodiments takes media encoded from the encoding system, and imports it into a storage array having a capacity of hundreds of terabytes. As it imports a digital media file, it fragments the media file into smaller segments (32 KB-1 MB “chunks” in one embodiment, chunks of at least 128 KB in another embodiment, for example) each of which it encrypts using best available encryption, which is currently military grade encryption protocols (128 bit symmetric key encryption). Various forms of encryption and various sizes of chunks may be used to provide segments. Media vaults of various embodiemnts may be “web enabled” thereby allowing authenticated users to configure the organization, the permissions, and the digital rights on each media file, including the wholesale and retails costs of each media file in detail. Media vaults can be used to syndicate feeds of a portion, or all, of its catalog to trusted outlet partners. Media vaults also may connect to the “super nodes” of a grid network (typically a peer-to-peer network) discussed below.

Super nodes, in some embodiments, are “directories” for client applications that allow clients to locate other clients that might be storing some of the small segments of the media on their local storage units. Thus, in some embodiments, super nodes supply clients with information that allow them to assemble these related small segments on the grid of computing devices, and reassemble them appropriately in the form of a correctly sequenced and continuous movie, book, audio, software or game application file. The super nodes may also authorize a user with the appropriate encryption key to unlock the media if the client application has permission to view that media.

Media player applications of various embodiments have the embedded protocol to launch through a partner outlet (a website, a set top box, cell phone or personal computer based application) and thereby access the grid network via the super node directory. Player applications are themselves likely to be portable to any number of computing devices.

According to one embodiment, syndication feeds are configured by media vaults to outlet partners (such as webportals and online merchants) that allow many different outlet partners access to the media vault contents on a highly controlled, monetized, and secure media delivery network. Syndication may flow two ways: First delivery of the media catalog to the outlet partner, and second, delivery of lists of authorized users that should have access to media on the media vault from the outlet partner.

According to an embodiment, the grid delivery network is the assemblage of thousand or millions (many) of client applications which all share, store, and consume segments of media data through an efficiently controlled, heavily encrypted, and accelerated pipeline of delivery of media files. This grid plays a key role in assuring consumers (end users) of high speed, low cost access to media.

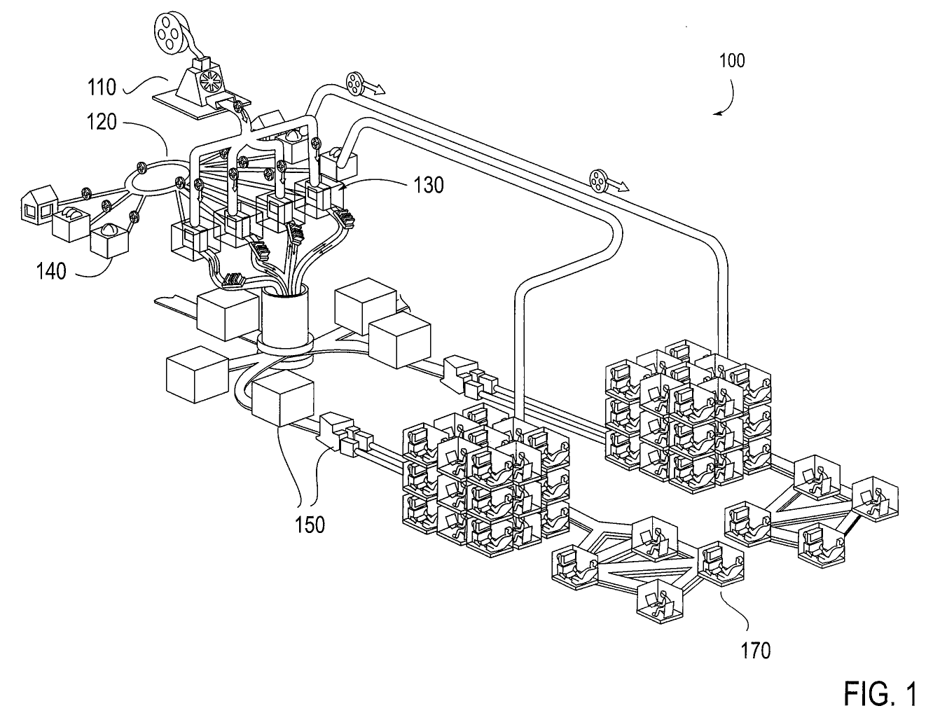

FIG. 1 provides an embodiment of a grid network. Studio 110 provides an embodiment of an encoding studio. In the encoding studio, digital media is delivered by customers (suppliers of media or media owners) for digital mastering into the network. Digital video is compressed, such as through a proprietary codec, digital applications are tested, checked, and sanitized in a test lab, digital audio is mastered into MP3 formats, and digital text or data is sanitized and quality checked before being transported to the media vault. Studios may be implemented in other ways as well in other embodiments.

Media vault 130 provides an example embodiment of a media vault. Each customer has access to their own secure media vault through a securely encrypted WWW interface to configure, upload, and manage their media files. Media may be configured for various levels of use, digital rights, pricing and cost controls, categorization, described in detail through exhaustive records, and images may be uploaded to provide visual images for the media. The entire (or only partial) media catalog can be configured to syndicate to trusted outlet partners, from one to many thousands. Media vaults may have special “outlet partner” gateways which are heavily secured using password protected and SSL encrypted “SOAP web services” allowing trusted outlet partners to allow or disallow their users to download media on the outlet partner's account. Media vaults are also accessible worldwide by the super nodes on the embodiment of the system described next. When importing digital media, the media vault segments the data into small encrypted chunks for distribution across the grid delivery network. The media vault may be inaccessible to the outside world other than by secured users, secured outlet partners, and secured super nodes.

Super node 140 illustrates an embodiment of a geo-located super nodes. Super nodes, as illustrated, interact with media vaults to download digital media securely from media vaults for distribution across the grid delivery network. Super nodes are located around the world, in a system where users will automatically navigate using related technology, as explained below, to the super node nearest to the user, geographically. This potentially allows for much faster Internet response times, and lower latency. Super nodes manage passing of data from media vaults to the user, including meta-data. Super nodes manage “job tickets” which authorize users across the network for short, controlled periods of time. Clients that do not have valid “job tickets” are not allowed to access the network. Super nodes may also manage the passing of “seeds” which are the first segments of the movie out onto the grid network, and manage the spread of the seeds intelligently to allow a network of thousands or millions of clients to interact effectively to stream movies at a low cost to the network. Super nodes handle authentication and the passing of digital keys securely to unlock segments of digital media for the purpose of viewing movies, listening to audio, or downloading software applications. Super nodes also handle the reporting of data from client applications about usage of the network for reporting purposes. Such a description of a super node may vary in other embodiments.

Vault interface 120 shows an embodiment of a gridcast vault interface which may be a tightly controlled and highly secure “internal network” accessible only by trusted users with regularly changed passwords, client authentication based on IP (internet protocol), and other complex authorization techniques. The entire internal network is controlled by one master “grid control” network, in one embodiment, which manages authentication among super nodes, between super nodes and media vaults, reporting of the grid usage, and system health among all critical systems.

Feed 150 shows an embodiment of syndication feeds, which are generated at the configuration of customers, who enter into agreements with trusted companies to distribute their data. The trusted companies may be called “outlet partners”. Syndicated feeds are generated on the media vaults by the media vault owners, and pushed to outlet partners via FTP (File Transfer Protocol). Outlet partners receive the syndicated feed, which, for example, may include all information needed to successfully build a website, or a set top box application, or a computer application to successfully build a distribution for those digital files. Syndicated feeds may be consumed via XML, and may thus also include XML schemas necessary for decoding the XML data, along with images necessary to showcase the products to customers on their website. When an end user selects a digital file to consume (e.g. movie to view) on an outlet partner website, the outlet partner presumably will first configure permission for that user to consume that data at the media vault. The media vault owner may set permissions and pricing on each of the housed files. The outlet partner thus agrees for each of the users it authorizes to download media files, that the outlet partner incurs that cost for later invoicing by the content owner.

Launch 160 shows an embodiment of the ‘web launch’ of a media file, which can also be a ‘set top box launch’ or ‘PC application based launch’, which is to say the user, after browsing the catalog of materials at an outlet partner, chooses a movie to download. The client application of the invention configures the browsing device to ‘launch’ or ‘run’ itself when a user chooses a digital file to watch. The client application decodes the launch data, and begins to contact the network to initiate the download of the movie.

Network 170 shows an embodiment of the “Gridcast” or grid delivery network which is a collection of potentially thousands or millions of client computers that are interconnected and in communication on a network layered over the Internet in a significantly complex exchange of data according to equally complex protocols, as explained in more detail below. A single client application may be downloading encrypted digital files, while at the same time sharing encrypted digital files with other computers transparently in the background. In order for the client application to learn of other clients sharing files it needs, the client application contacts the super node server for a “node list”, a list of clients that are likely storing significant portions of the digital file, and which also have desirable speeds to connect to. After receiving the list, the client application begins contacting other clients using TCP/IP (the major Internet data transmission protocol) to initiate data exchange. Clients, even those not actively downloading digital files, are generally configured to share with other clients around the clock.

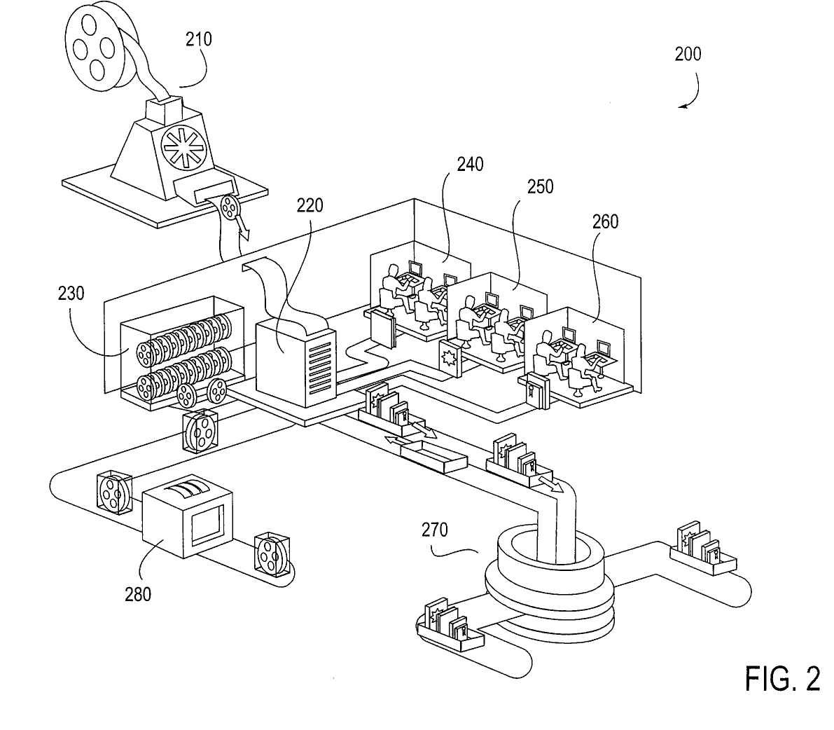

FIG. 2 is a more detailed view of the media vault in one embodiment. Vault 220 shows the media vault has three major groups of outside “groups” that connect to it to perform functions in the illustrated embodiment. The first group is shown in items 240, 250 and 260. Items 240, 250 and 260 illustrate human users that connect to the media vault through a sophisticated SSL and HTTP DIGEST password authentication procedure. After being authenticated, the users are allowed access to the media vault 220. End users may have preset a variety of permission levels to allow them to perform certain tasks they are entrusted to do, but not others. Each user can be configured granularly to perform some tasks that others may not. Each function on the media vault may thus be configured. The three main user groups may be accountants, catalog managers, and digital rights managers. Accounting users may use the media vault to draw up usage reports which are used to bill outlet partners for media usage, to monitor the costs of the network, and to gain vital statistical information about the network. Catalog managers may configure the media in the media vault, enter data describing in detail every aspect of the digital media, import digital media, scan and upload images into the media vault, assign serial numbers to media, and manage workflow for other users. Digital rights managers may monetize the pricing and costs for each media file, manage the use rights by users, and classify the quality and quantity of media that may be downloaded by configurable user groups.

Encoder 210 provides the “importing” function of the encoding studio to load the media vault with digital media. Data storage 230 illustrates where that data resides, which is in a large storage area network array of hard disks that are redundantly linked to defer catastrophic disk failure in one embodiment. Other storage options may be used for similar purposes in a distributed fashion, for example.

Super node 280 illustrates the interaction of the media vault with a single super node in an embodiment. The media vault may connect to dozens, even hundreds of super nodes which may be configured through a grid control network device or otherwise provisioned. Super nodes are configured to interact with media vaults to download digital media description records, to download encrypted segments of media to “seed” the network and to validate authorization by users in order to pass securely to client applications decryption keys necessary to use those digital media files. Interface 270 illustrates interaction services with the media vaults in an embodiment. Interface 270 allows for interaction with outgoing syndication feeds, and provides an incoming client authorization gateway for media outlet partners.

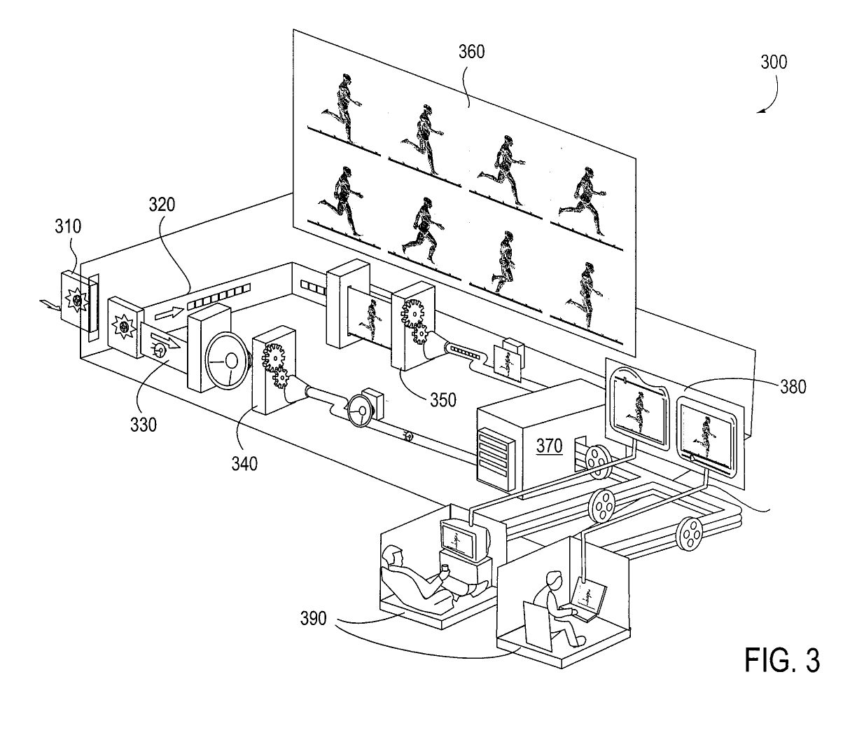

FIG. 3 illustrates the codec “code/decode” module for encoding digital movies, one of the many types of files supported in various embodiments. Video media must be converted and “compressed” as in a raw state the media is quite large. Sophisticated algorithms may be used to “compress” the data into a small enough file to provide fast transmission across broadband Internet or other networks. For one particular codec, the concept is to divide a movie into successive batches of eight picture frames each and to compress the first frame of each batch in its entirety. For each batch, only the data for the second frame that has “changed” from the first frame is encoded. This process of compressing only data changed from a prior frame is repeated through the eighth frame. The resulting file is a mix of audio and video data which is in a more transportable form than raw media data. The change or delta information for the succeeding frames may approximate the change information in MPEG encoding, for example.

To encode the data, media file 310 is provided and split into video stream 320 and audio stream 330. Video encoder 350 provides encoded (compressed) video data and audio encoder 340 provides encoded (compressed) audio data. Finish module 370 combines the encoded audio and video data into a single encoded file. At the client application 380, the video is “decoded” into an actual movie file which displays on a monitor, television set, hand held device, or other display technology observed by users 390 at a rate approximating 24 picture frames per second in one embodiment. All of this allows for transport and recreation of rendered media file 360 for observation by users 390 at potentially remote locations.

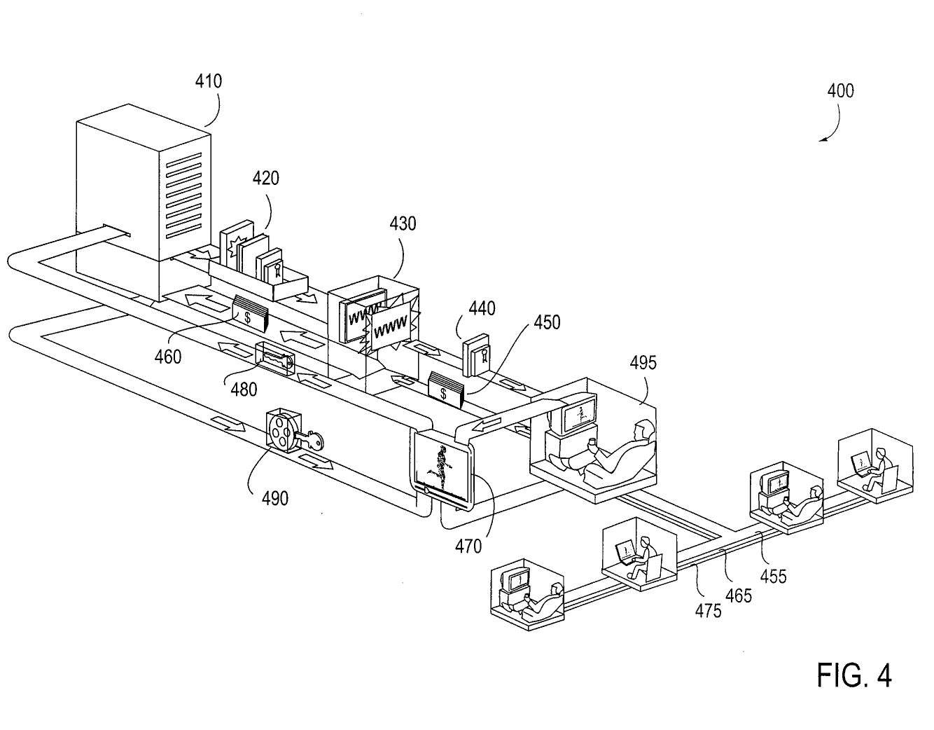

FIG. 4 shows details for syndication feeds, which are configured at the media vault and can be complete, or partial catalogs contained on the media vault as accessed through a super node 410 in some embodiments. The full catalog can be “filtered” based on permission levels, rental types, media types, categories (recursively subcategorized or not), and a variety of custom programmed filtering. In XML feed 420 one can see an XML feed being sent to an outlet partner website using the File Transmission Protocol (FTP). The outlet partner website 430 receives the file on an FTP server on a regular schedule (also configurable), and uses that XML data, XML schema, and contained images to build a website, set top box, hand held device, or PC application to allow their consumer users to browse the media in their syndicated feed for viewing. Some of the media in the feed may be set for a permission level which the user would need to be given access, usually in exchange for a monetary fee by the outlet partner. For example, after the users pays the fees (450) to the outlet partner website 430, if necessary, the outlet website then communicates with the media vault via a secured “SOAP web service” (460) which allows those outlet partners to grant users permission to view those files. Usually, the media vault 410 owners will then bill the outlet partner 430 for use of their content. Other financial arrangements are of course possible as well, for example, the user may have a paid up account which is decreased each time it accesses media service by deducting a fee; or it could have a credit account that is charged a fee each time it accesses media. A variety of arrangements are possible in alternative embodiments.

Transfer 440 illustrates a web launch, with the client application “run” to begin downloading the media file from across the grid delivery network. Application 470 is the client application, which in this context is shown checking its own authentication 480 via the super node 410 to the media vault. If authentication is granted (based on permission level, subscription status, or pay per view rights), then the user is passed an authentication key (490) to unlock the encrypted segments being downloaded from the grid delivery network (peer-to-peer connections 455, 465 and 475), and then allowed to watch the movie (495).

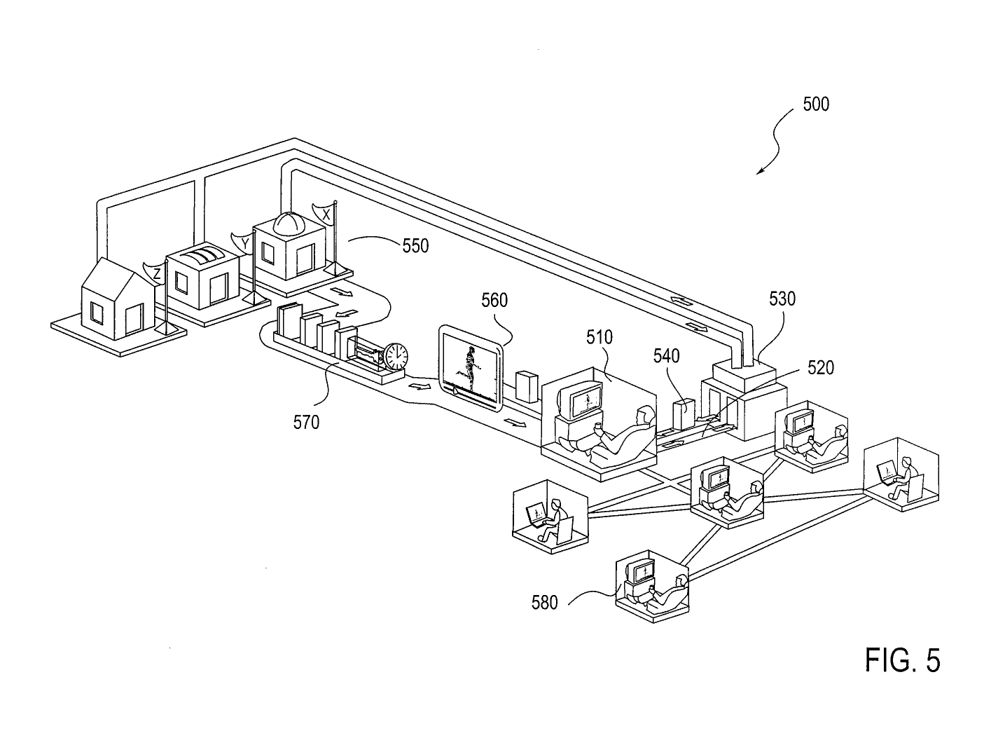

FIG. 5 shows the mechanisms in which the super nodes interact with the client application in an embodiment. After a “web launch”, or analogous event, the user (client) then is required to “resolve the domain name” (520) of a super node network. Via the well established “Domain Name System”, the user is delivered the IP address (540) of the closest super node to the user, geographically, which allows the user to connect to a faster, higher speed, and likelier more responsive server. The DNS server (530) used is custom programmed to perform this rare “geographic” lookup. Of the super nodes 550, for purposes of illustration, this user is resolved to be closest in geographic region to the Toyko, Japan super node. The client 510 then goes through the process of downloading meta data, acquiring a “job ticket”, downloading seeds if necessary, authenticating and obtaining decryption keys, and reporting usage data back to the super node (process modules 570). In network 580, the user (client) is downloading the movie 560 from grid network clients which were discovered at the time a job request was answered, which also contains a full node list of all clients currently sharing the media file.

It should be noted that all files across the network are described by a “master hash”, which is generated using 160 bit SHA1 digest algorithms in an embodiment. Each “segment” of a digital media file is described in a similar 160 bit fashion. Every segment and every master hash is therefore a unique “name” on the network for download in these embodiments. This also means that the digest algorithm producing the hashes can be used to “verify” that the segment is valid.

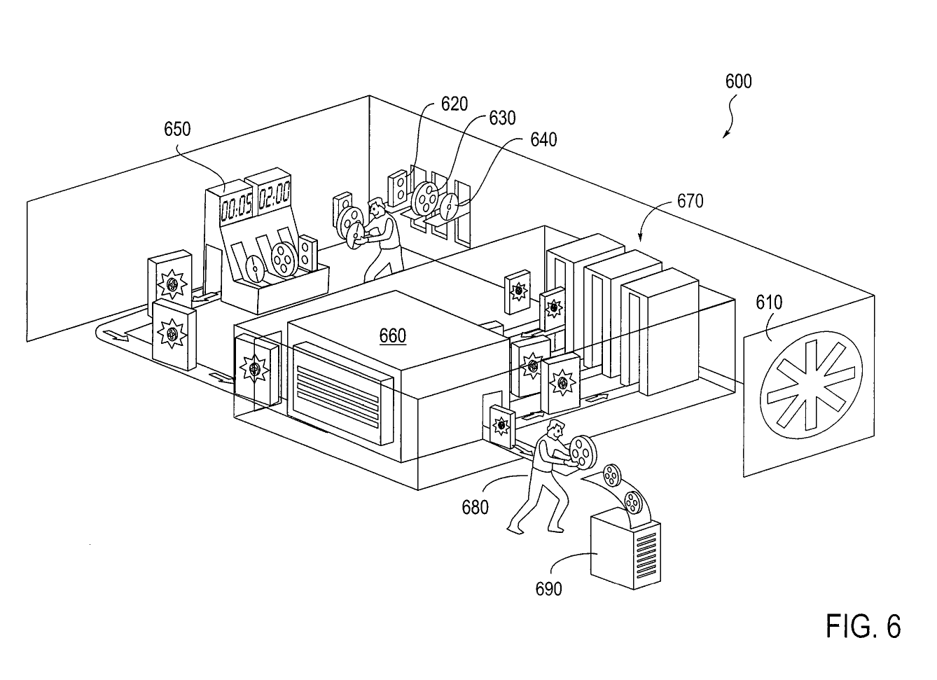

FIG. 6 illustrates the encoding studio, which is a complex array of machinery and software programs charged with the intensive task of digitizing video, audio, software, and data media files, and then encoding those files for use on the grid network. At interfaces 620, 630 and 640, videos are received by an encoding studio manager, who first inspects the movies, and loads them into the digitizing workstations 650. The video formats acceptable are DVD, VHS and 35 mm film stock. Using commercial software to digitize the media, the “raw media files” are passed into a “storage server” (660) which holds the data waiting for an encoding computer to become finished with an encoding session. When an encoder (670) is done with a job, it immediately contacts the storage server looking for files that are waiting to be encoded. The encoder then pulls the entire digital media file into its system, and begins the complex process of encoding movies into a format (FIG. 3) suitable for transport through a network, which can take up to 10 hours per 2 hour movie media file. After the encoder is done, the resulting encoded media is digitally copied to the storage server (660). As the storage server fills with digital media files waiting to be transported to a media vault, a technician 680 copies the encoded files to a “sneakernet” drive 690, which is essentially an external array of redundant disks for transportation by foot, automobile, or delivery service to the customer media vault, which theoretically can be located anywhere in the world.

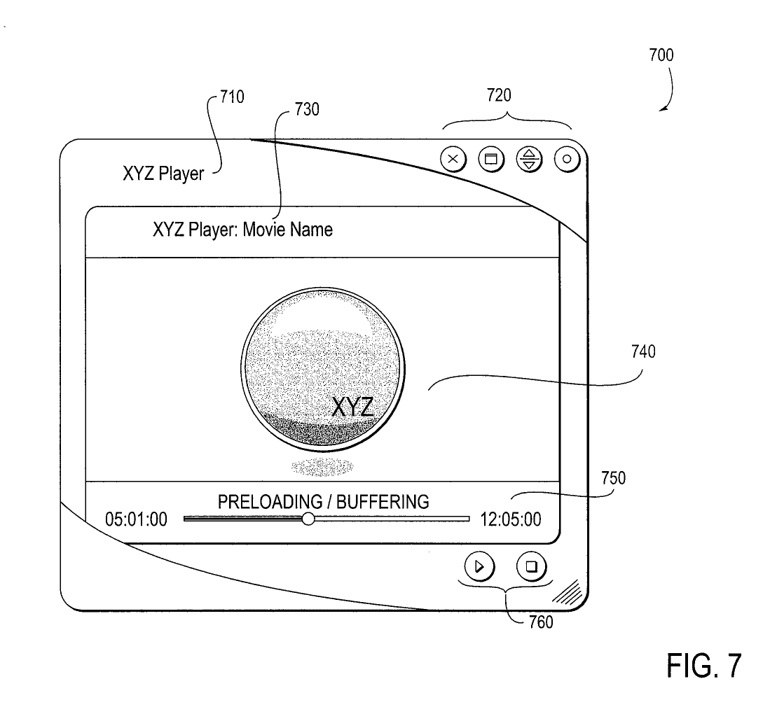

FIG. 7 provides an example of an embodiment of a player, a typical implementation of an interface that integrates into the grid network client technology for video playback in some embodiments. These depictions show the video player from the perspective of the end-user. The player application itself employs a dynamic “skin” approach to its presentation look and feel. The choice of “skin” (and thus the appearance of the player) is derived from vendor, media library, and target language information contained in the media metadata given the player when starting a movie (see “VSI file”, below). This allows for customization per vendor, and per locale, as appropriate. When a client launches from one media outlet, it may look completely different from the client launched from another outlet. For example, the Flixz skin of FIG. 7 would be displayed for movies launched from that website. Outlet partners may require custom skins. If a skin does not exist locally on a client computer, the client “fetches” this skin, downloading and installing it for use. Interface 700 as illustrated includes brand 710, window controls 720, title 730, media display 740, status bar 750, and player controls 760.

The video player as shown provides for common video playback manipulation and features, including full screen toggle, volume and mute selection, and the functionality for play, pause, and position of the video playback. Most of these features are handled by the hosting video system technology. However, the features concerning playback, pause, and position are implemented in context to the underlying grid network implementation, as they require communication between the player and the grid network engine (client) to keep the delivery of the media synchronized to the playback.

Although the implementation portrayed in the diagrams focuses upon the context of video playback, the components unique to the grid network platform are principally the same for other types of media and/or content presentation. This includes but is not limited to audio formats, large-format documents such as books, blueprints, photo collections, etc, ISO CD/DVD images for the creation of hard-copy media, executable and/or installable software applications, and virtually any other form or format of digital content and presentation. The processes for obtaining, validating, and delivering the requisite media content is the same for all media types. The benefits of security, accounting, and the efficiencies of peer-to-peer transport persist regardless of the media type. To facilitate differing forms of media presentation, the end-result rendering subsystems need only be interfaced to appropriately (see the presentation interface component, below). Time-based media, such as audio and video, require additional services for synchronization and time-sensitive delivery. These services are provided for by the grid network technology.

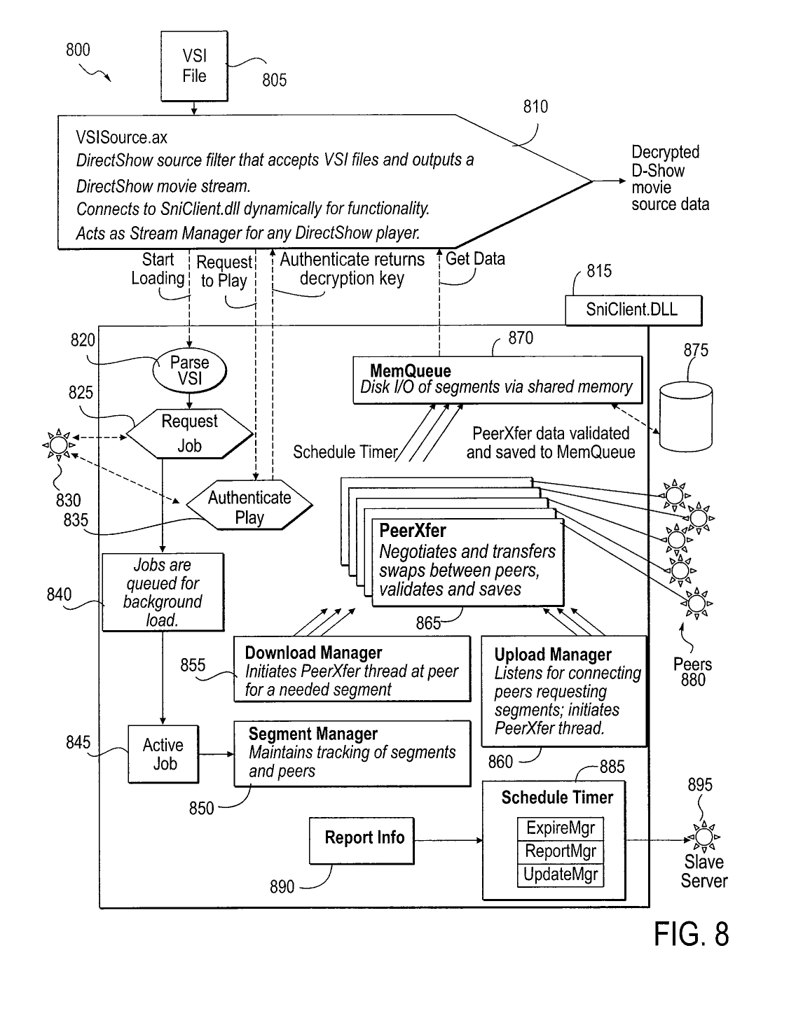

FIG. 8 shows a conceptual overview of the grid network client as implemented in the context of a video streaming player interface in some embodiments. While this overview is illustrative of the components whch may be found in such a system, this is not the only option for implementing such a system—other embodiments may use similar or different implementations. The primary components of the grid network client are as follows, and may be found similarly labeled in the diagram:

VSI File 805: For each media content type, there is a corresponding metadata file. These files are known as “VSI” files within the nomenclature of this embodiment. These files contain information about a particular piece of media—a movie, for example—and contain information regarding the media type, vendor codes, and permission and rental types. These files also contain the various formats in which the media is available. This includes possible multiple selections at differing download bit rates, and different languages.

Local Store 875: The “local store” is a portion of the user's hard disk storage (client local storage) that has been set aside for the purpose of holding media segments. Media segment are encoded and saved under the name of their SHA1 hash. The segments that constitute a particular piece of media are recorded under the SHA1 hash name of that media (the hash of the entire media file). This local store area is routinely maintained to keep the total size of all media segments “pruned down” to a predetermined (and configurable) maximum store size (typically, 2 GB in this embodiment).

MemQueue 870: A shared memory section, known as MemQueue 870, provides two separate primary features. For one, it may be used as a caching mechanism to hold one or more segments in memory rather than on the local store disk, as an efficiency mechanism. The other feature of the MemQueue 870 shared memory is to act as an IPC (inter-process communication) mechanism by which the separate processes of the player and the grid network client can communicate.

Presentation Interface Component (VSISource.ax) 810: The Presentation Interface Component 810 is the intermediate component that translates the media delivered by the grid network into a usable format suitable for the media-rendering engine. In the embodiment detailed in the diagram, this is done within the wrappings of a Microsoft DirectShow Filter component (VSISource.ax). Implementations for other operating systems and/or other video rendering subsystems may use similar host-appropriate wrappers to implement the same necessary grid network-specific functionality.

The player requests data for streaming or otherwise presenting the media in much the same way as a request would be made to the operating system to receive data from a file. It is at this layer that the Presentation Interface Component 810 makes its primary interface with the rendering engine. Requests for data are fulfilled through communication via MemQueue 870 to the grid network client to determine which of the media segments in the local store contain the requested data range. Using the Digital Rights Management (DRM) encoding keys provided by the grid network client, the component then decrypts these segments and returns the requested data. The remainder of the downstream rendering process continues as though having retrieved data from a local file, and the media is rendered for the end user. No file that can be directly rendered or copied exists on the client system at any point in such an embodiment, thereby providing potentially enhanced security. Moreover, as different wrappers and codecs may be used, rendering to different formats for display or use, or for storage (e.g. rendering to a DVD-type of media) may be an option simply based on the available presentation interface component 810.

Job 825: A grid network “Job” is a validated request for media. The grid network client, using information obtained from the VSI file 805 presented to it, obtains the Internet IP address of an appropriate server by performing a DNS resolution on the domain name. Geo-locating name services will provide the server nearest the client. The grid network client will then contact this server requesting a “Job Ticket” 830, and a “Node List” of peer nodes that are local in common with the client. The Job Ticket 830 is a time-limited validation and key that peers use to verify that a connecting peer is authorized to receive the data it is requesting. The server also provides the client with a list of all the segment hashes, in order, that make up this media file. This list of segment hashes is used both to request and to validate the data transmitted between peers.

Active Job 845: Jobs may be queued in queue 840, and processed in turn, or they may be promoted for immediate download. Jobs may be set to download in either “asynchronous” mode, meaning that the order that the segments received is not important, or in “synchronous” mode, meaning that the order in which the segments are received are important to playback, and requires additional synchronization between the rendering player and the grid network download engine. By default, jobs are queued in asynchronous mode. In the context of a typical video-on-demand request, the newly requested job is activated immediately, suspending any currently active job, and placed immediately into synchronous mode for immediate playback. This behavior, however, is adjustable depending upon the needs and wishes of the user and the delivery context.

Segment Manager 850, PeerXfer 865, Upload Manager 860, Download Manager 855: These components as labeled in the diagram, work together to provide the core peer-to-peer transfer functionality, as well as transfers with the seeding server if necessary. The process works by first making contact with another peer. This may occur by finding a peer in the server-supplied node list and initiating a connection, or another peer may have initiated a connection with the client. Several simultaneous connections may be made. The total number of connections that can be made is a configurable value, but is also limited by the maximum bandwidth of the Internet connection as recorded (e.g. in a client or user profile).

Once communication has been established and job validation has been approved, the peers are joined for the purpose of swapping segments until there is no longer a mutual advantage to staying connected. The segment swapping process includes the client asking a peer for a particular desired segment while also communicating what segments the client has available (known as an “offer list”). In response, the remote peer sends the header information of the requested segment (if available), along with its own request from the offer list provided. It also communicates its own current offer list. These exchanges continue between peers until such time as one or both have nothing more to offer one another.

In a one-sided exchange, which can occur when one peer is downloading a movie ahead of another peer that doesn't have these segments yet, the leading peer may elect to not terminate the connection even though it does not currently benefit from it, as long as it is far enough ahead of its own playback position to comfortably adopt such a stance. If both peers are comfortably ahead of their playback positions, then the order of segments need no longer be sequential, and exchanges between the peers can occur on a much more liberal basis. Using an algorithm that requests those segments a remote peer has that are the “rarest” segments among all the connected peers, a more even distribution of segments among connected peers is promoted. This helps to insure a homogenous distribution of segments across the grid and works to further reduce the circumstances where a peer may be forced to contact the seed server due to a lack of peers for a particular segment.

When a segment arrives at the client, it is processed to validate that its SHA1 hash is the same as the given segment name. This validation ensures that the data did not experience any corruption. The inter-relationship between the Presentation Interface Component 810 and the segment manager 850 is of particular importance. During playback, the player continually announces its current playback position. From this, the grid network is able to determine its sense of “urgency” regarding the order and preference to download segments in. If there are empty segments not far ahead of the playback position, then the emphasis is placed on receiving these segments as soon as possible. If this distance begins to become too short, and/or there is a limited amount of download bandwidth available among the connected peers, then a connection to the seed server may be initiated in order to maintain the target download rate without interrupting the movie playback.

If the playback position is moments away from running up against an empty segment, the grid network client sends a message to the player instructing it to pause, and wait for sufficient buffering before continuing. If there is a sufficient stretch of contiguous segments ahead of the playback position, the grid network client is free to be more responsive to the needs of other peers ahead of its own, including responding to requests for segments from its local store that it is not currently engaged in downloading. This allows peers watching a different movie to benefit from the local store of clients who are not necessarily watching the same movie at the same time.

Segment Manager 850 may thus manage segments stored locally on the client and interact with a player to determine the status of segments buffered in relation to the segments playing. PeerXfer 865 may transfer data to and from other peers. Upload Manager 860 may manage uploads of data to other peers as needed. Similarly, Download Manager 855 may manage downloads of data from other peers as needed. Thus, each of these four components may be involved in setting and interacting with an urgency level for the client.

Local Store 875 Inventory and Maintenance. The local store 875 is periodically inventoried, and if it is beginning to become full, pruned down to size. The inventory is also used to report the relative percentages of the available media in store to the server so that those clients that have portions of a media file available may be tracked and ordered to produce the node lists distributed to other peers in an intelligent fashion. This inventory task is performed in parallel to other functions of a grid network, keeping inventory accounting and maintenance updated frequently, but without delaying the performance of the application as a whole. The inventory amounts are reported both during regularly scheduled report submissions, and also during the request for a new job.

Reporting 890: At regular intervals—a configurable time period in some embodiments, but typically 12 hours or more—the client will report 890 on various summary and transaction statistics. This statistical data is primarily used to determine node performance, to analyze weak spots in the grid, and to identify those nodes that are strong client performers versus those who are not. This helps to provide optimal node lists for peers. The data is reported using the schedule timer 885 to a slave server 895.

Automated Updates: The grid network client also provides a facility by which new versions of the software can be automatically delivered, and the client updated. In periods where there is no current activity and the application is idle, a request is made to see if there is a new version available, given the current version and host platform. If so, the installer for this new version or patch is downloaded, installed silently and the program is then resumed. Alternately, the user may be notified of the arrival of a new update, allowing the user to initiate actual installation. Such an automated mechanism is important to the evolving nature of the product and is a feature that users have come to expect from products of similar sophistication.

A typical scenario involving a video-on-demand playback using grid network would transpire as follows. Refer to FIG. 8 during the description of this process: The player is given a VSI file 805 to process. This is done typically through a handoff from a Web Browser (not depicted here), but could also be through a direct file access or other means. The VSI file 805 is then parsed for information required to request a Job from the nearest server. The returned Node List and Job Ticket are used to make contact with other peers on the network thought to have some portion of the movie. The movie is immediately placed into playback mode, and thus begins streaming, beginning with the data needed to initiate playback.

Wherever possible, segments are received from one of the many peers available. In this way, the media content is distributed without bandwidth cost to the primary server. In the event that no available peers have a needed segment, or if too few peers exist in order for the client to maintain the minimum bit rate, the server will be contacted, but only for as long as needed. In such an event, a new node list is periodically requested, in the hopes of finding enough peers to break free of the dependence on the server.

In most contexts, little or no content will be retrieved directly from the super node or a seed server. However, for little-used media, or for first-corners to newly released media, the server will be relied upon more than at other times. As peers continue to swap segments with each other, the downloaded segments are written to the local store of the client. Here the player, through the Presentation Interface Component (VSISource.ax) 810, reads the data from the store where it is decrypted and presented in final form for playback. The user enjoys the movie, perhaps moving the playback position to see different parts of the movie, and thus changing the “urgency” and thus the handling of segment requests by grid network, as described. When the movie is done, the grid network client continues running in the background, and is available to continue serving requests to other peers as called upon. Periodic inventory and reporting tasks keep the maintenance tasks and reporting tasks current.

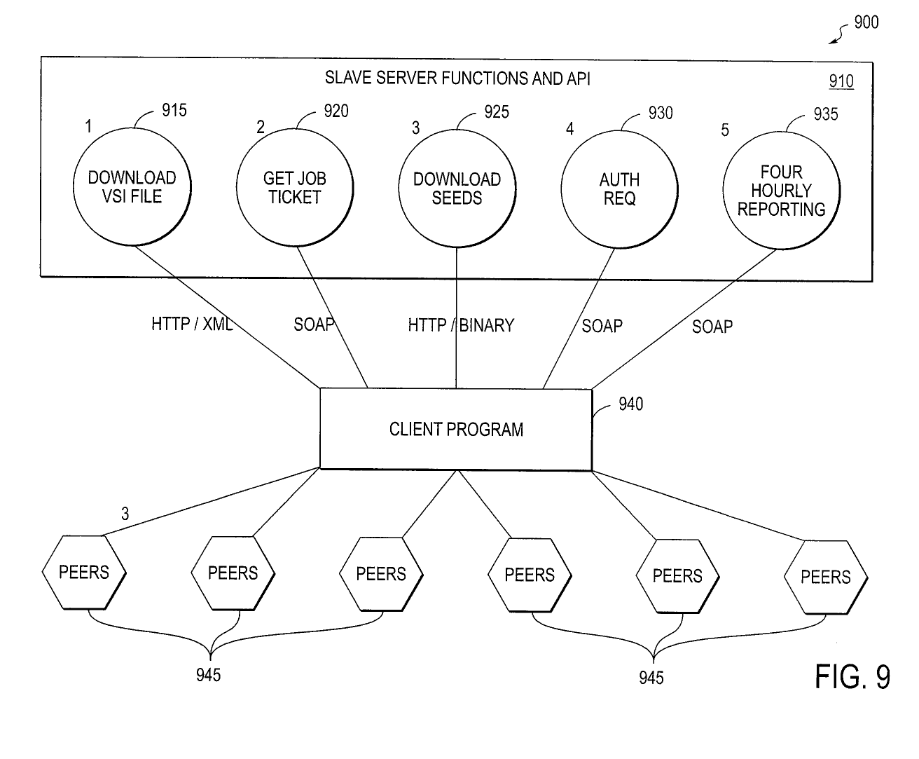

FIG. 9 illustrates operations between the slave server, client and peers in an embodiment. Thus, the slave server 895 of FIG. 8 can provide a number of functions to the client 815 while the client also interacts with peers 880 to exchange file segments. Slave server 910 of system 900 provides functions such as downloading a VSI file 915 (file identifier), getting a job ticket 920, downloading seeds 925 (seeded segments), responding to authorization requests 930 and periodic reporting 935. Client program 940 interfaces with the various functions and related modules of slave server 910 using HTTP or SOAP protocols which may be extended or applied in various ways. Client program likewise interacts with peers 945 to exchange media file segments, using a job ticket for exchanges and using seeded file segments for some of the exchanges. Client 940 reports its status periodically, and downloads a VSI file or requests authorization as required to either initiate a new file download or to verify another peer's job ticket.

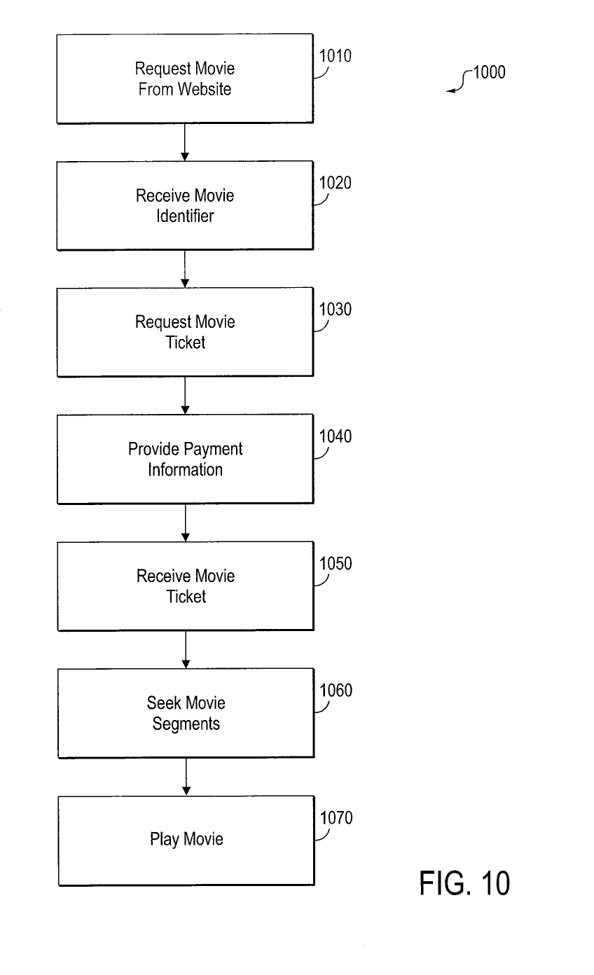

FIG. 10 provides an illustration of an embodiment of a process for playing a movie file from a grid network. Process 1000 includes requesting a movie or similar media file from a website, receiving an identifier for the file, requesting a ticket for the file, providing payment information, receiving the ticket for the file, seeking segments of the file, and using the file. Process 1000 is described in particular with reference to a movie file, but other types of media files or data files may be used with process 1000 in other embodiments. Process 1000 and other processes of this document are implemented as a set of modules, which may be process modules or operations, software modules with associated functions or effects, hardware modules designed to fulfill the process operations, or some combination of the various types of modules, for example. The modules of process 1000 and other processes described herein may be rearranged, such as in a parallel or serial fashion, and may be reordered, combined, or subdivided in various embodiments.

Referring again to the specific example of a movie file, a request for a movie file may be submitted to a website at module 1010, such as through an HTTP submission, for example. In response, a movie identifier is provided by the website at module 1020. The movie identifier, in one embodiment, is a hash value for the movie file, which may be a perfect hash, or may approximate a perfect hash. Upon receipt of the movie identifier, a movie ticket (or job ticket) is requested at module 1030. A provider or website may also require payment in order to produce a job ticket, and payment information may be provided at module 1040, such as through a user interface or via a user profile, for example. In instances where a user has an ongoing subscription, a user profile may indicate this status, for example. Alternatively, credit card information may either be stored in some form of profile or provided at the time of purchase, for example.

With payment received and a title selected, a movie ticket is received at module 1050. The movie ticket may include information about when it is valid, what movie it is for, and where the related movie file may be obtained, for example. An example movie ticket embodiment is discussed further below. At module 1060, a process of seeking movie segments initiates. The segments of the movie file associated with the ticket are sought within a grid network of machines, with segments found on various machines and potentially received in an unordered fashion. The movie is played at module 1070. This may occur responsive to enough early segments of a movie being received as part of module 1060, allowing for receipt of additional segments while the movie plays as part of module 1070. Thus, modules 1060 and 1070 may operate in a parallel fashion, potentially with interaction to determine whether upcoming segments are available or what upcoming segments are needed.

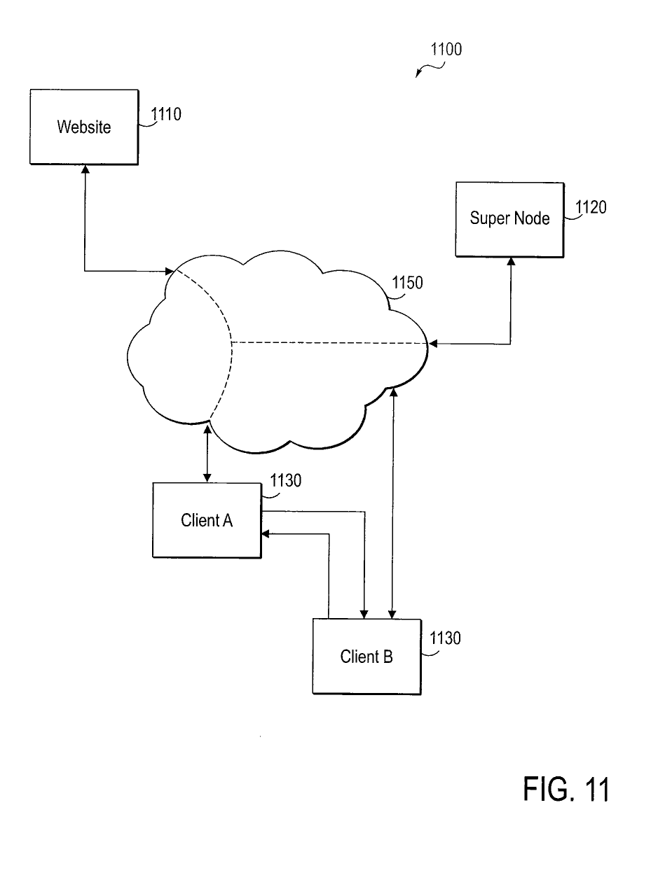

Various systems may be used in conjunction with movie tickets and movies or similar combinations of job tickets and media files. FIG. 11 provides an illustration of an embodiment of a grid system. System 1100 includes a website, a super node, clients A and B, and a network. Additional components, such as additional clients and super nodes are not illustrated.

System 1100 includes website 1110, at which information about movies or other media titles can be obtained. Client A (1130) may access website 1110 through network 1150 (which may be the world wide web, for example). After finding a title at website 1110, Client A (1130) may then request the associated movie, and receive from the website 1110 an identifier for the movie. Furthermore, Client A (1130) may then request a job ticket for the movie, allowing viewing of the movie at Client A (1130), for example. This may involve paying or proving payment to the website 1110.

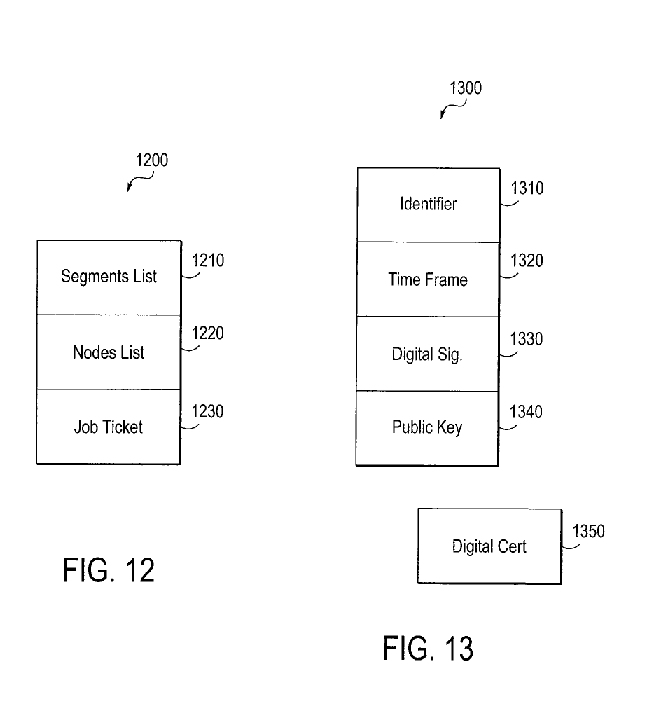

Typically, a job ticket may be issued by a super node 1120, which may be geographically located in a location relatively close to Client A (1130) in some embodiments. Super node 1120 may issue a job ticket as part of a packet such as that illustrated in FIG. 12, for example. FIG. 12 provides an illustration of an embodiment of a packet used in response to a request for a data file. The packet 1200 includes a segment list, a node list and the actual job ticket. Thus, the segment list 1210 may provide a list of segments, which may be represented as hashes of the segments, along with a value for the total number of segments, for example.

Such a structure may allow for tracking of whether segments have been received, for example. Moreover, such as structure allows for a verification check as part of fulfilling a request for a segment—the client receiving the request for the segment can determine whether the request includes the proper hash value. Similarly, the hash value may be calculated from the associated received segment to verify the correct segment was received. The hash value may be a 160 bit hash value such as a SHA1 hash value in some embodiments. The sheer number of hash values in such a situation allows for a near-perfect hash—each hash value uniquely identifies the segment in question. Moreover, the hash value for the segment is only intended to be unique when paired with the hash value for the surrounding file (such as a movie file) in some embodiments. Thus, the hash value of the segment effectively includes the hash value of the movie file, representing a 320 bit hash encoding for each segment.

Similarly, a node list 1220 may be included, providing a list of nodes which have segments of the subject movie media file, for example. Furthermore, the node list may include a further field with encoded data related to which segments are present at a given node. This data may be maintained by the super node 1120 and updated responsive to data submitted by clients.

Job ticket 1230 may include a number of different fields. A unique identifier of the job transaction as issued by the super node, a valid timeframe, a digital signature created by the super node authenticating these two pieces of information, and a copy of the common public key of the signing certificate are given to the client upon the request of a new job in one embodiment. FIG. 13 provides an illustration of an embodiment of a job ticket. Identifier 1310 is a unique identifier known to the originating super node that uniquely identifies the job request. Timeframe 1320 may contain valid ‘to:’ and ‘from:’ times in which segments on this job may be authorized for trading among peers or from the seed server. Digital certificate 1350, known by the super node, is used to create a digital signature of the information found in the identifier 1310 and the timeframe 1320. This digital signature (1330) can be used along with the common public key of the certificate (1340) to authenticate that a super node issued the job ticket. When connecting to peers (requesting a file), the identifier 1310 and timeframe 1320 are transmitted along with digital signature 1330. The remote peer or seed server can authenticate the job ticket information originated from a super node and is therefore authorized to trade segment information with the requesting client.

With an authenticated job ticket 1230, Client A (1130) may seek segments of the relevant movie file. The job ticket 1230 may be presented to Client B (1140) to request segments based on Client B (1140) being listed on the list of nodes 1220. Client B (1140) can verify the ticket with super node 1120, and then send the appropriate segment(s) to Client A (1130). Thus, a peer-to-peer (virtually direct) coupling between Client A (1130) and Client B (1140) may be established. This coupling will likely still involve actual traffic across network 1150, but it may be illustrated as a more direct connection. Moreover, segments are generally sent on an ongoing basis, until Client A (1130) signals that it no longer needs segments.

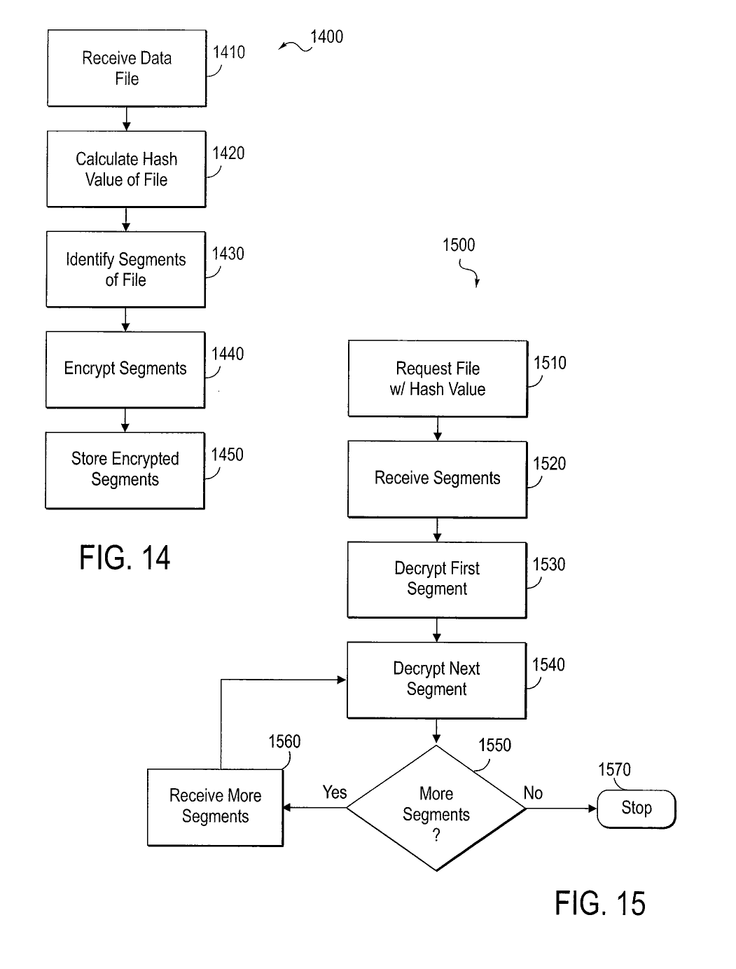

FIG. 14 provides an illustration of an embodiment of a process of encrypting a media file. The process broadly includes hashing the file (calculating a hash value) and then encrypting segments of the file. Process 1400 includes receiving a data file, calculating a hash value of the data file, identifying segments of the data file, encrypting the segments and storing the encrypted segments. Types of files which may be encrypted include various types of media files, such as movie, sound, animation, text, and other files.

Process 1400 may begin with receipt of a data file for encryption at module 1410. At module 1420, a hash value for the file is calculated. The hash value may be calculated using a perfect hash process, or using a process intended to nearly simulate a perfect hash. For example, a 160 bit hash value is calculated in one embodiment. While this is not necessarily a perfect hash, it may be sufficiently close, as ˆ2160 provides a vast number of unique identifiers. Thus, the hash value, for all practical purposes, may be used as an identifier for the file.

With an identifier calculated, segments of the file are identified at module 1430. This may be as simple as dividing the size of the file by a predetermined block size and then segmenting the file based on the predetermined block size. Alternatively, it may involve determining a desirable block size, and then dividing the file. At module 1440, the segments are encrypted. In one embodiment, the segments are encrypted using a process based on chain-block-blowfish symmetrical encryption, with each block encrypted in part based on the encrypted version of the previous block. With the segments encrypted, the segments may then be stored at module 1450, for later distribution.

Having the segments stored, one may then request the segments to reassemble them in decrypted form into a file. FIG. 15 provides an illustration of an embodiment of a process of using an encrypted media file. The process includes requesting a file, receiving segments, decrypting the first and then subsequent segments, and continuing to receive and decrypt segments.

Process 1500 initiates with a request for a file using a hash value as an identifier at module 1510. Segments of the file are received at module 1520, with the first segment received within module 1520. At module 1530, the first segment, sequentially within the file, is decrypted. This may involve the hash value of the file, and may also involve some form of digital signature, for example.

At module 1540, the next segment of the file is decrypted. If this occurs immediately after decryption of the first segment, the next segment is the second segment. However, the next segment may be expected to be the next segment sequentially in the file after the last segment decrypted. At module 1550, a determination is made as to whether there are more segments to decrypt. If yes, the process moves to module 1560, where more segments are received (if necessary) and then moves back to module 1540 for decryption of the next segment. This may be repeated until a determination at module 1550 that no more segments need to be decrypted, at which point the process terminates at module 1570. Note that the process may terminate because the end of the file has been reached, because the file has been closed (presumably will not be accessed), or because a segment was not received and an error has occurred, for example.

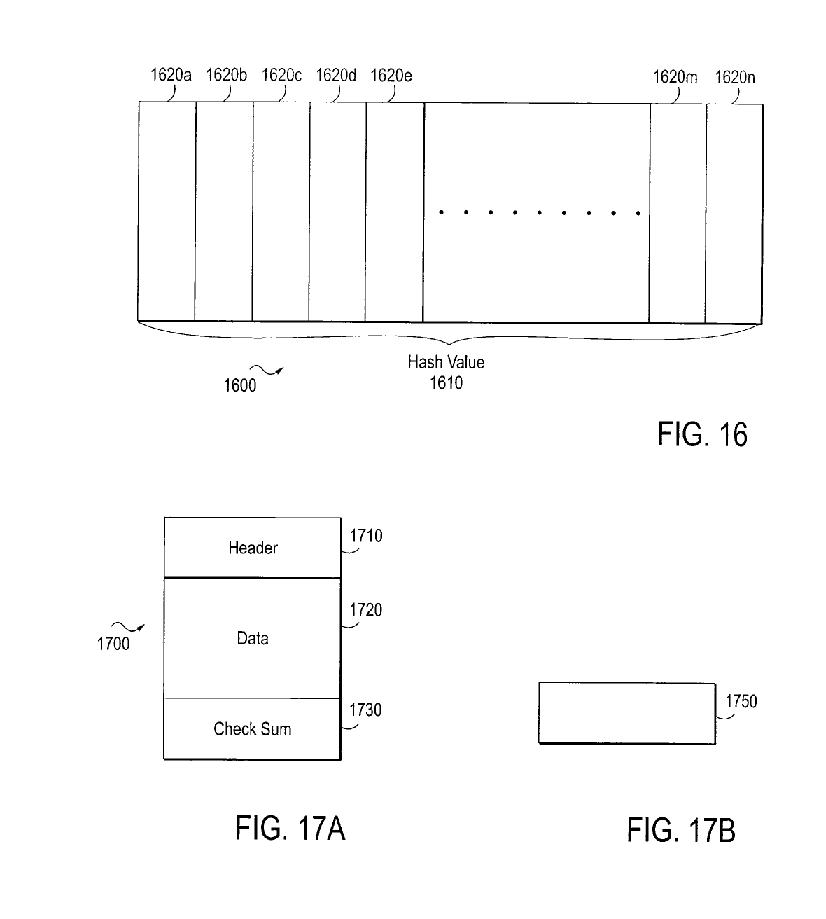

Various structures may be used in conjunction with the processes of FIGS. 14 and 15. FIG. 16 provides an illustration of an embodiment of a media file. Media file 1600 is a file which has been segmented and for which a hash value has been calculated. Thus, hash value 1610 is illustrated, based on the entire file. Hash value 1610 may thus be a value such as value 1750 of FIG. 17B—a scalar value which may be stored or transmitted as an identifier. Segments 1620 are illustrated as sequential segments in file 1600. Thus, segment 1620a comes first, followed sequentially by segments 1620b, 1620c, 1620d, 1620e, and eventually by segments 1620m and 1620n. When encrypting the segments of file 1600, segment 1620a is encrypted first, then segment 1620b is encrypted based in part on segment 1620a, and so on.

After encryption, the segments may be stored. FIG. 17A provides an illustration of an embodiment of a segment of a media file. Segment 1700 includes a header 1710, a data payload 1720 and a checksum 1730. Each portion of segment 1700 may originate with the encryption process. Thus, header 1710 may include identifying information such as the media file identifier and a segment number, for example. Data payload 1720 may include the actual encrypted data (potentially with that data interacting with other parts of the segment or external data during the decryption process). Checksum 1730 may provide some form of a parity check or a more elaborate indication of whether segment 1700 is itself intact. In contrast, FIG. 17B provides an illustration of an embodiment of a hash value of a media file, which may be as simple as a scalar numerical value, for example.

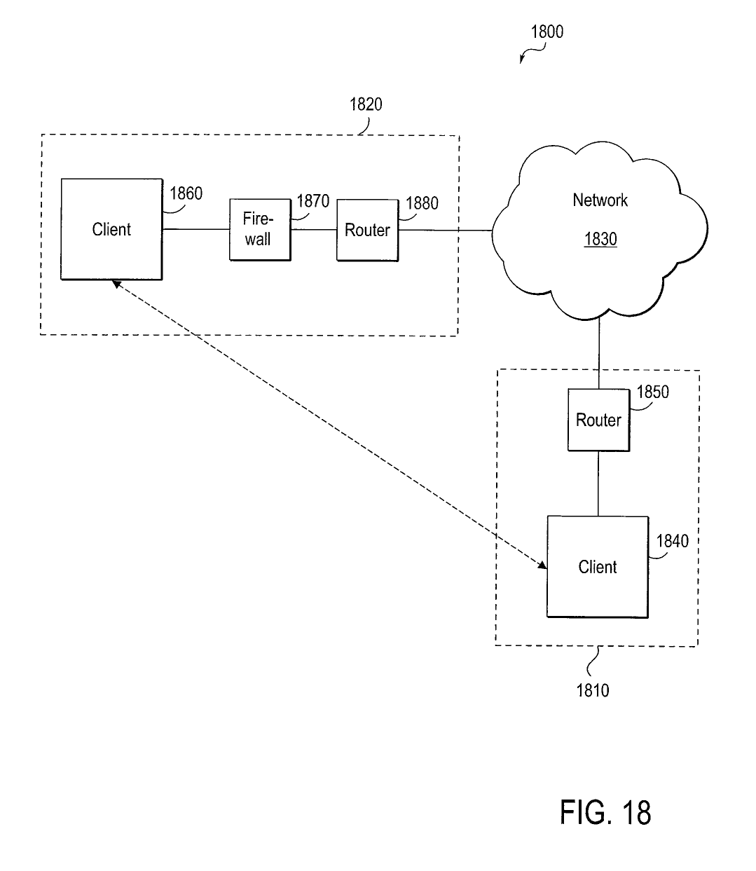

Within a grid network, some clients are publicly accessible, and some clients are hidden behind firewalls. FIG. 18 provides an illustration of an embodiment of a grid network. System 1800 includes (as illustrated) a first client site 1810, a second client site 1820, and a network 1830 therebetween. This simplifies an overall grid network, in which a multitude of clients may be present, along with various types of servers. Client sites 1810 and 1820 are logical sites—they may not represent a single physical location.

Client site 1810 is a public client—so named because it can be accessed relatively easily by other clients—there is not firewall. Client site 1810 includes client 1840 and router 1850, which are coupled to network 1830. Client site 1820, on the other hand, is a private client—it has a firewall interposed which blocks unauthorized or uninvited access. Client site 1820 includes client 1860, firewall 1870 and router 1880, all of which are coupled to network 1830. Firewall 1870 blocks unauthorized access to client 1860.

Blocking unauthorized or uninvited access may (and often does) involve blocking all incoming requests which are not responsive to a prior outgoing request. Thus, if client 1840 requests file segments from client 1860, and no prior outgoing request from client 1860 established a path through firewall 1870, then firewall 1870 may block communications from client 1840. While this provides advantages in defending against malware, it inhibits unsolicited communication. What is potentially desired is a communications channel between clients 1840 and 1860 in the form of a peer-to-peer or similar structure.

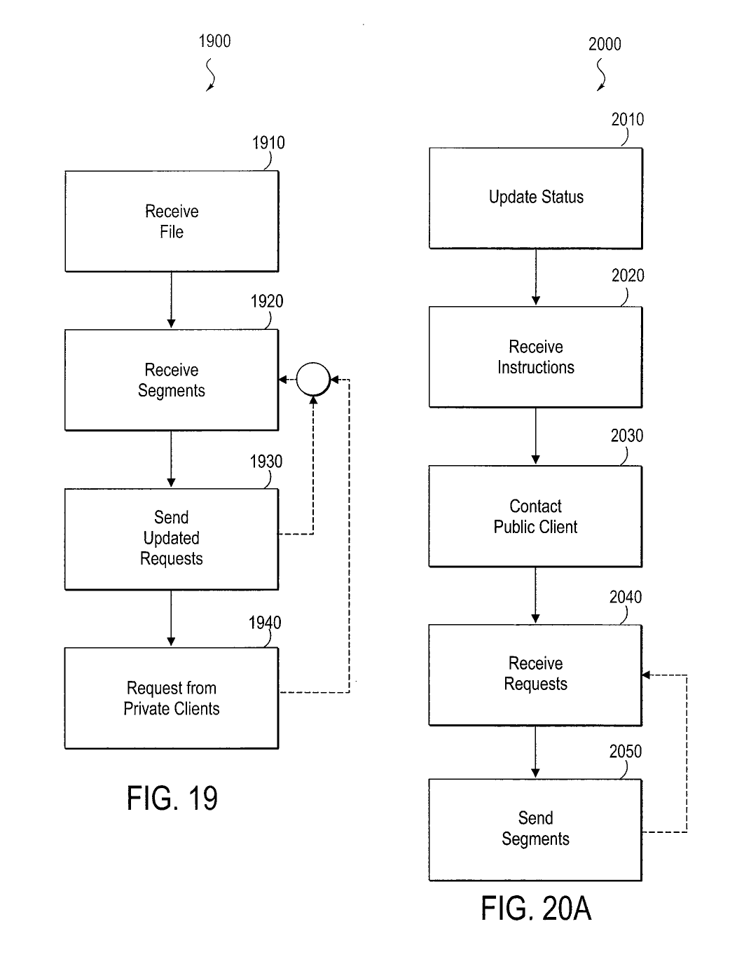

Client 1840 may initially request a media file through network 1830. FIG. 19 provides an illustration of an embodiment of a process of requesting a media file. Process 1900 includes requesting the file, receiving segments, sending updated requests, and receiving requests from private clients.

At module 1910, process 1900 initiates with a request for a file. With the request sent to various peers, segments arrive at module 1920—the requestor begins to receive parts of the file. Based on what parts have been received, the requestor may then send out modified requests or updated requests for missing parts of the file at module 1930, and update a server about what has been requested. Moreover, the requester may receive requests to initiate communications from private clients at module 1940. These requests may indicate that the private client was notified of the requestor's need for files, and is inviting communication through the private client's firewall.

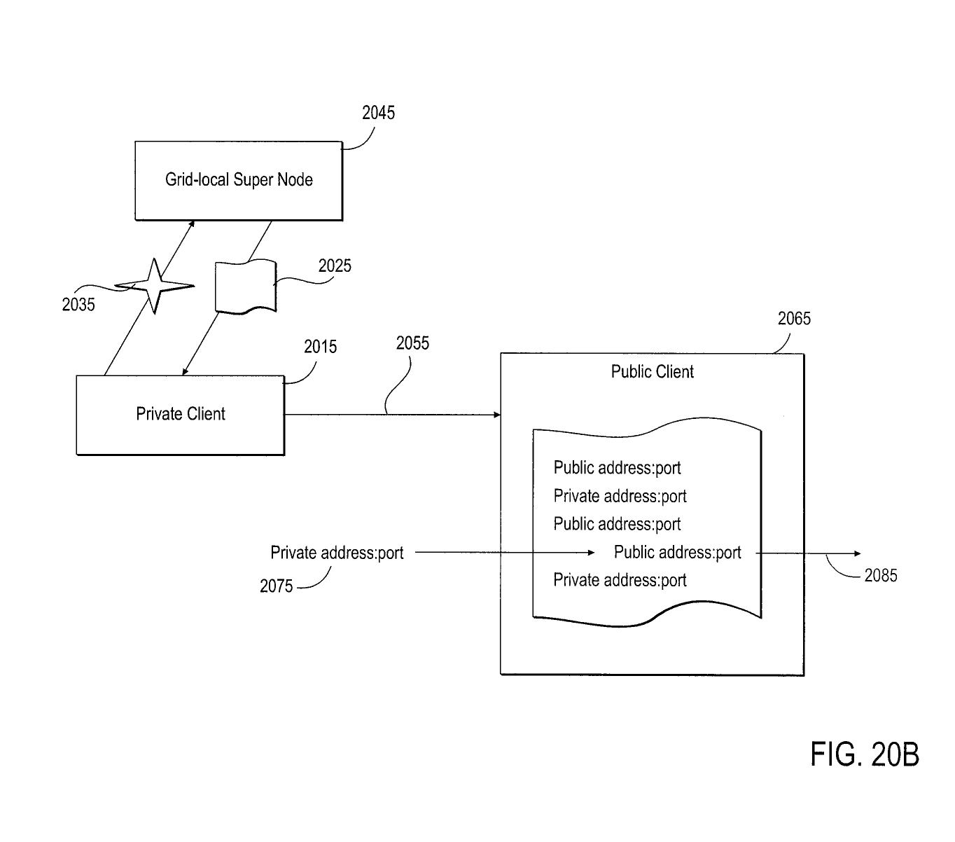

While the public client is requesting a file, a private client in turn requests communications with the public client to provide a path for a request for the file back from the public client. FIG. 20A provides an illustration of an embodiment of a process of assisting a request for a media file. Process 2000 includes updating status with a server, receiving instructions, contacting a public client, receiving a request, and sending segments.

Process 2000 initiates with a status update at module 2010. A private client communicates its status to a server and indicates it is available to supply segments. Presumably, the server has access to information about what segments the private client has, and can determine whether the private client should supply segments. Based on this information, the private client receives instructions from the server about what other clients to contact to offer to supply segments at module 2020.

With these instructions, the private client initiates communications with a public client at module 2030, such as by requesting communication related to a file requested by the public client. Responsive to the communication of module 2030, the private client receives at module 2040 a request from the public client for segments of a specified file. At module 2050, the private client sends segments to the public client, and the process then may repeat as long as appropriate. Note that this process suggests that communication of segments occurs in a unidirectional manner. However, transfer of segments back from the public client to the private client may also occur. This may involve segments of the same file or movie in both directions, or may involve segments of multiple files in one or both directions, for example. Essentially, the process of having the private client contact the public client initially assists in establishing communication where no communication would otherwise occur.

This assist process can be a useful part of making a grid network function. In a grid network, multiple clients can serve a single client seeking segments. Thus, a single client may receive segments from anywhere from one to sixteen or more clients. However, many clients may be located behind firewalls. Thus, those clients, referred to as private clients, may not be accessible to most public clients, thereby cutting off a significant portion of available grid resources.

Client systems that are behind a firewall—so called private clients—cannot be contacted directly by remote peers seeking segments. A peer-to-peer connection may be refused if it is not authorized prior to the request. Therefore, a super node will not list these clients in the list of peers advertised to clients seeking connection opportunities. The node list presented by the super node typically includes only public client nodes. However, this places the full burden of discoverable resource sharing upon this subset of the total node space of the grid, resulting in a less-than-optimal configuration.

To counter this, the assist protocol may be used to allow private clients to initiate a connection with publicly accessible clients that are thought to be interested in their resources. Once a connection has been established, the connected client may elect to free up one of its existing public connections in favor of the new private one. In this way, offloading connections to private clients wishing to “assist” works to reduce the burden upon public nodes across the network, and potentially allows the entire network to function more efficiently.

FIG. 20B illustrates an embodiment of an assist process in a grid network. Client 2015 is behind a firewall and is thus not publicly addressable by outside peers (a private client). Should client 2015 determine that it is not currently busy with another job, and that it has resources within its local store that may be useful to share, it initiates contact with super node 2045 for the purpose of providing an assist service.

An assist notification (2035) contains a brief inventory of those assets that the private client is able to share effectively. This may be in the form of a packet or other similar data structure transmitted through the network to the super node. The super node 2045 then identifies public nodes known to be actively trading segments on this media, and returns a list of these clients to the private client 2015 via response 2025.

Private client 2015 may then initiate contact with one or more of the public nodes in the list, via a connection request 2055. The receiving public client 2065 recognizes that the connecting peer 2015 is a private client, and after determining that this peer 2015 is indeed offering resources that are presently needed, accepts the connection. It may then choose to release a currently connected public peer.

The determination to release a currently connected public peer is based upon the overall availability of connected peers and the present urgency need for receiving segments. If the client can “afford” to release a public peer in favor of the newly connected private one, it will do so. In such a case, the connection 2075 of the private peer replaces the previous public connection 2085, and communications with public connection 2085 are stopped. Should receiving client 2065 determine that it can not afford to replace a currently connected public node (as may be the case if only a few peers are currently connected), the connection 2075 with the new private client 2015 may simply be added to the list of currently connected peers.

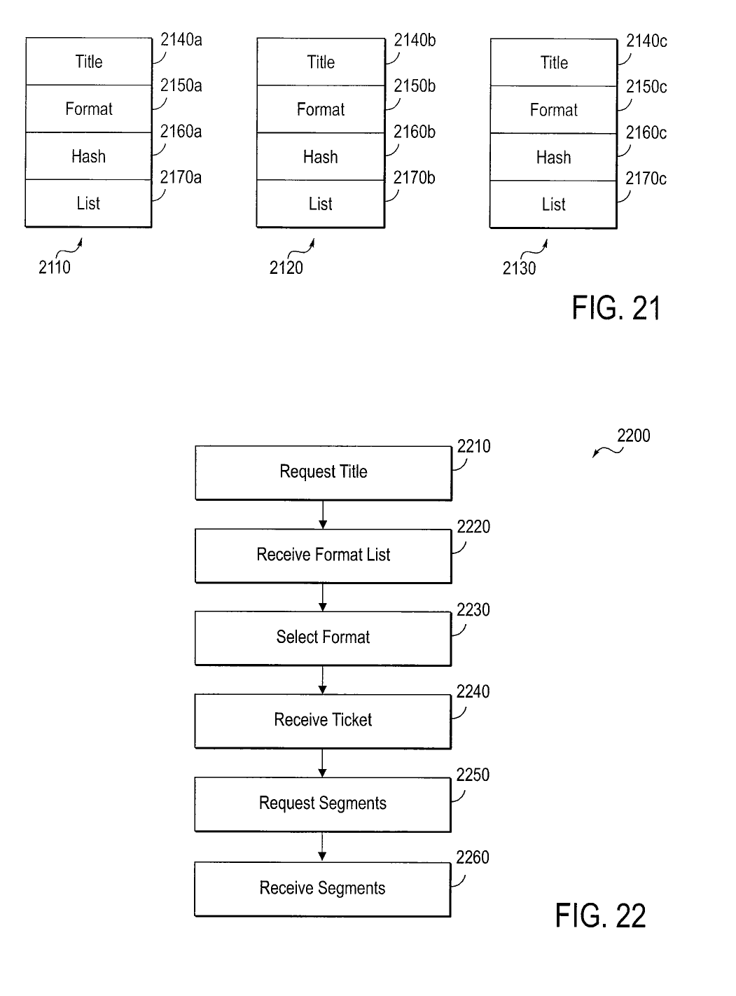

Files may be provided in a variety of different formats, consistent with capabilities of different clients on a grid network. FIG. 21 provides an illustration of a set of files in an embodiment. The set of files may each have a different format, while sharing other characteristics common to many files used within the grid. Thus, each of the files includes a title, format, hash, and list of segments, along with the segments (the actual data).

For example, first file 2110 may be a file encoding the movie “This is Spinal Tap” in Windows Media format (available from Microsoft). Thus, title field 2140a would encode the title, “This is Spinal Tap” such as in a character string, or as an index into a table of titles, for example. The format field 2150a would encode the format for Windows Media (or a particular codec), such as through a name (Windows Media), a type (wmv) or some other identifier such as an index into a table of file formats, for example. The hash field 2160a would include a hash of the actual data of the file, for example. The list field 2170a would include a list of the segments of the file, such as a scalar number of segments followed by a packed bitwise representation of the segments, for example. Not shown are the actual segments, which would follow the illustrated header of the file.

A second file 2120 may similarly encode a movie, potentially the same movie as file 2110. However, second file 2120 may encode the movie for Quicktime, available from Apple, for example. Thus, title 2140b would encode the title “This is Spinal Tap” similarly (potentially identically) to title 2140a. Format 2150b would encode a format such as Quicktime, “mov” or an index. Hash 2160b would include the hash of file 2120, which would likely be different from the hash of file 2110, due to differences in encoding. List 2170b would provide a list similar to list 2170a, but corresponding to the segments of file 2120. Likewise, the actual segments (not shown) would follow.

As one may expect, a third file 2130 may also be encoded. File 2130 may be a completely different file (e.g. “The Care Bears Adventure”) or it may be a different format of the same movie. This description assumes yet a third format, e.g. a format for Real Media Player. Title 2140c would be similar to or identical to titles 2140a and 2140b. Format 2150c would be an encoding of RealMedia, “ram” or an index, for example. Hash 2160c would again be a hash of the actual file, and thus likely different from hashes 2160a and 2160b. Similarly, list 2170c would be a list similar to list 2170a and 2170b, followed by the actual segments.

With the various different files available to satisfy needs for different file formats, a process of providing those files may be useful. FIG. 22 provides an illustration of a process of providing a file in a desired format in an embodiment. Process 2200 includes requesting a file, receiving an available format list, selecting a format, receiving a ticket, requesting segments, and receiving segments of the file. Thus, process 2200 provides a client-side process for requesting and receiving a file in a desired format.

Process 2200 initiates at module 2210 when a client requests a title—an identifier for a movie which does not indicate a specific format. A format list for the title in question is received by the client at module 2220. At module 2230, the client selects a desired or needed format. Selection of a format may be based on a negotiation between the client and a server (automatically selecting a format based on capabilities), based on a user selection, or may be based on a default selection previously made, for example.

Responsive to selection of the format, a ticket for the movie is received at module 2240. The ticket may be a ticket such as was described above with reference to FIG. 12, for example. Thus, the ticket may be expected to include a hash value, an indication of when the ticket is valid, a list of segments, and a digital signature or certificate, for example. With the ticket, the client requests segments of the file at module 2250. In response, the client receives segments at module 2260. As one may expect, the process may shift between modules 2250 and 2260, with the modules potentially operating or executing in parallel, until the movie is completely received.

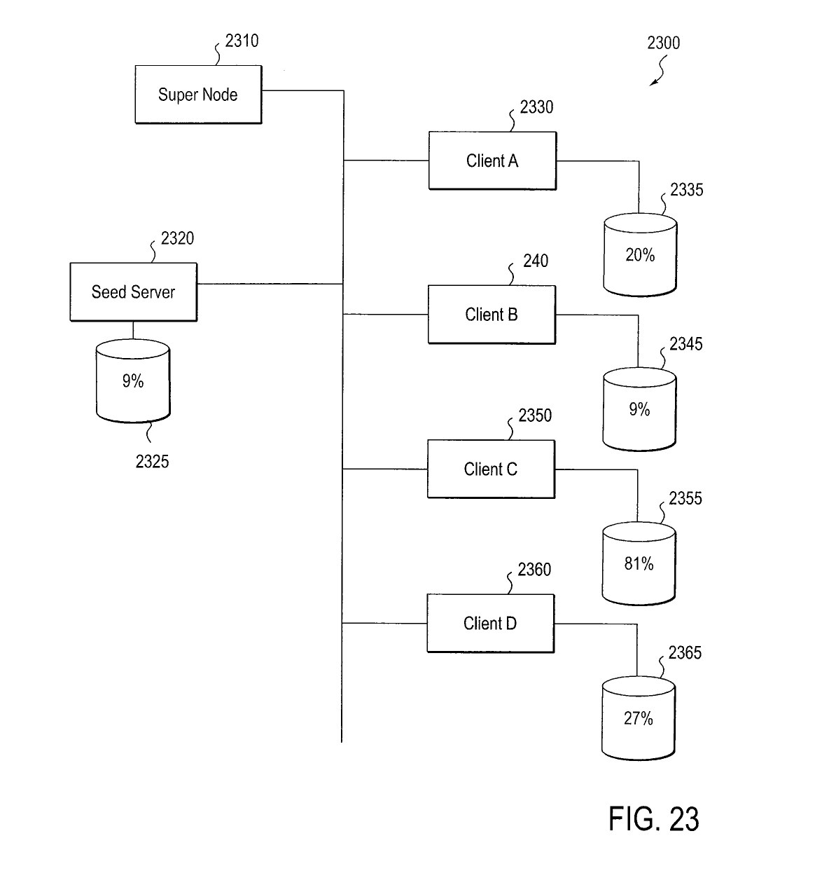

Reference to a example system sharing a file may be useful as well. FIG. 23 provides an illustration of an embodiment of a system in which a file is being shared. System 2300 includes a super node, seed server, clients A-D and associated repositories. As illustrated, a single movie file is being shared—and by way of example, client A 2330 may be the client seeking segments and playing the movie file. Thus, client A 2330 would have received authorization and a job ticket from super node 2310. Client A 2330 would also report to super node 2310 its status on a periodic but relatively infrequent basis (such as once every 45 minutes in one embodiment). In the snapshot illustrated, Client A 2330 has 20% of the movie file in question stored in local repository 2335.

Client A 2335 may thus request segments from client B 2340, client C 2350 and client D 2360. Client B 2340 has 9% of the file in question in local repository 2345. Client C 2350 has 81% of the file in question in local repository 2355. Client D 2360 has 27% of the file in question in local repository 2365. All communications of segments, job tickets, or other communications occur along network 2370, in various modes. Thus, peer-to-peer connections may be established along network 2370, or broadcast messages may go out along network 2370. In particular, client A 2330 may establish a peer-to-peer connection with client C 2350 (for example) and start sharing segments, or at least receiving segments.

If a segment is not present at any accessible client, the segment may be requested from seed server 2320, which holds 100% of the file in question in its local repository 2325. This is preferably a last resort, as sharing among peers on the network is desired. This request also passes along network 2370.

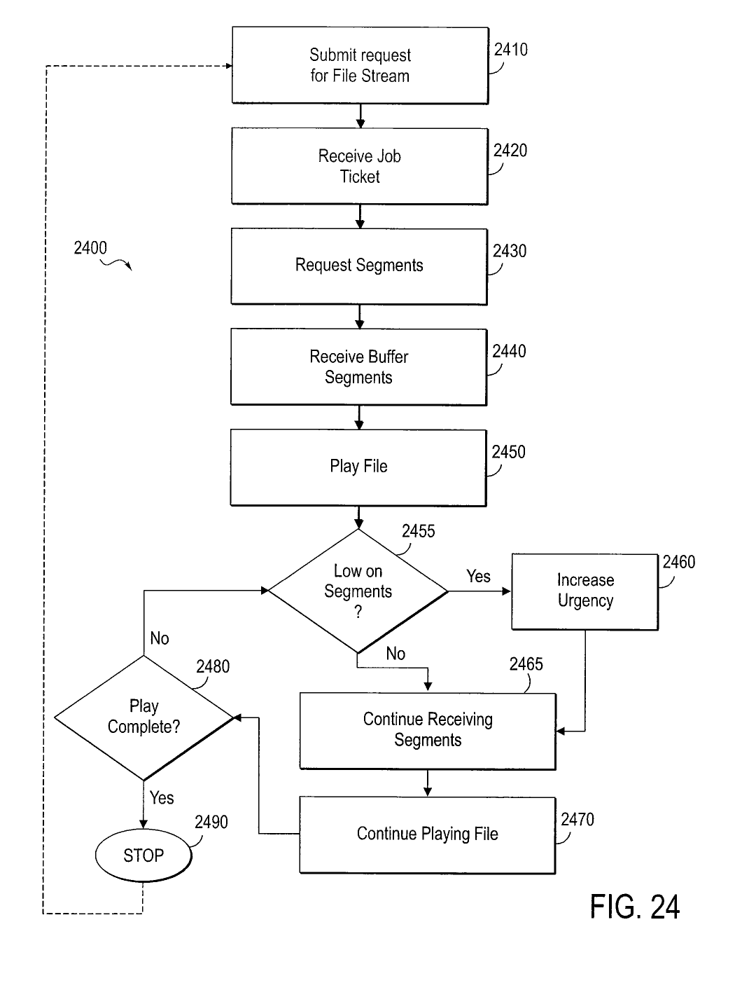

While playing a movie is often desired, how the movie is played may not be as important to the user. However, owners of content may prefer that a movie or other long content file be streamed rather than transferred as a complete file. Additionally, memory limitations may make storage of an entire file difficult. FIG. 24 provides an illustration of an embodiment of a process of receiving a file stream in an embodiment. Process 2400 includes requesting a file, receiving a corresponding job ticket, requesting segments of the file, receiving buffer segments, playing the file, determining if the buffer is low on segments, increasing urgency for low segment status, continuing to receive segments, determining if play is complete, and discarding segments.

Process 2400 initiates when a client submits a request for a file stream, such as for a movie file at module 2410. A job ticket is received, such as was described with respect to FIG. 12, for example, at module 2420. With the job ticket, at module 2430, a client or user requests segments of the file stream through a grid network. Initially, buffer segments are received at module 2440. These buffer segments will include segments making up the beginning of a sequential file, but may also include later segments which may be held until needed.

When enough buffer segments are present, at module 2450, the movie file is played (or a different type of sequential file is processed). Thus, having a sufficient initial buffer in place, the file begins playing, as with normal streaming. However, the segments of the file are encrypted and organized as described with respect to the segments of files referred to above—rather than simple unencrypted packets, for example. The segments that are played are decrypted in what approximates a just-in-time type of process of decryption—a segment is decrypted for play when the time comes to play it. Thus, the encrypted segments are essentially rendered for the screen (for a movie) through a process of decryption and normal rendering (for the file format).

At module 2455, a determination is made as to whether the buffer is running low—there may not be enough segments to continue playing the file soon. If yes, an urgency level is increased at module 2460. The urgency level may be used in a variety of settings, such as simple file requests or seeding of files. The urgency level may be communicated as part of requests for segments or for other purposes. Regardless of the urgency level, at module 2465, the process continues receiving segments. As one may expect, given the streaming nature of the process, at module 2470, play of the file continues. At module 2480, a determination is made as to whether the end of the file has been reached. If not, the process returns to module 2455 to determine segments status and then continues with modules 2465 and 2470. If the end of the file has been reached, as the file was streamed, the process terminates at module 2490. Not specifically illustrated is that the rendered segments are discarded after use on a nearly continuous basis. Thus, the encrypted segments remain, but the unencrypted segments only persist long enough to display (or otherwise use) the segment in question.

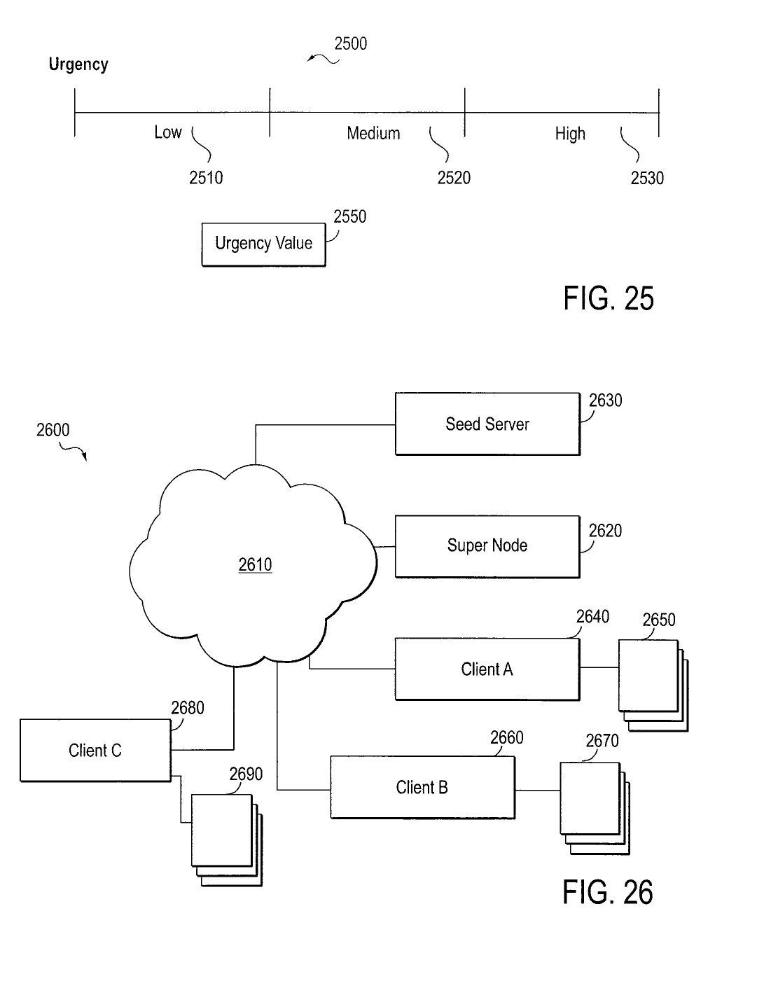

Urgency provides a powerful tool for requesting segments in general, and particularly for streaming. FIG. 25 provides an illustration of an embodiment of a representation of urgency. An urgency level may lay along a spectrum or range of urgency levels 2500. As illustrated, low urgency 2510 provides one end of the range 2500. Medium urgency 2520 provides a middle portion of the range 2500. High urgency 2530 provides another end of range 2500. The actual urgency level may be encoded as a scalar value—an urgency value 2550.

In one embodiment, low urgency generally corresponds to request which are serviced in the normal course of processing, although urgency levels are still factored into servicing by a client receiving the request. In such an embodiment, medium urgency requests are serviced ahead of low urgency requests, and may be inserted at favored positions in a queue, for example. Moreover, medium urgency requests near the high end of the range may receive additional special handling and may be monitored within a grid network, for example. High urgency requests may trigger unusual or extraordinary behavior. For example, seed servers in a grid network may begin to service high urgency requests, to avoid a buffer underrun condition, for example. Moreover, higher urgency levels may trigger servers to cause more assist transactions to be directed to clients with higher urgency levels, for example.

Urgency and streaming of files may be understood with reference to an example grid network embodiment, for example. FIG. 26 provides an illustration of an embodiment of a grid network. Network 2600 includes an overall network, a seed server, a super node, and clients A, B and C. Network 2600 is representative of various grid networks, but does not provide all details of such a network.

Overall network 2610 is a network such as the internet or an intranet, for example. Coupled to network 2610 is super node 2620, which may be a controlling node for grid network 2600. Also coupled to network 2610 is seed server 2630, which may provide segments of various files and effectively serve as a repository for segments on the network 2600. Furthermore, client A 2640, client B 2660 and client C 2680 are coupled to the network 2610. Client A 2640 has coupled thereto segments 2650, which are local copies of segments accessible by client A 2640 on local storage. Similarly, client B 2660 has coupled thereto segments 2670 which are accessible by client B 2660 on local storage. Additionally, client C 2680 has coupled thereto segments 2690, which are stored in local storage accessible by client C 2680.

Thus, client A 2640 may request a file for streaming purposes. Segments of the file may be located, among other locations, at client B 2660 and client C 2680. Initially, client A 2640 may request segments with a low level of urgency, and receive segments back from clients B 2660 and C 2680. Should client A 2640 run low on segments during play of the file, it may increase its urgency level, and continue to request segments. With the higher urgency level, clients B 2660 and C 2680 may prioritize request from client A 2640 higher. Should client A 2640 continue to have a potential buffer underrun problem, client A 2640 may increase its urgency level further. This may result in seed server 2630 supplying segments directly to client A 2640. Furthermore, super node 2620 may potentially direct assist efforts to client A 2640 and also potentially direct seed server 2630 to respond, depending on the overall landscape of segments available when the process starts, for example.

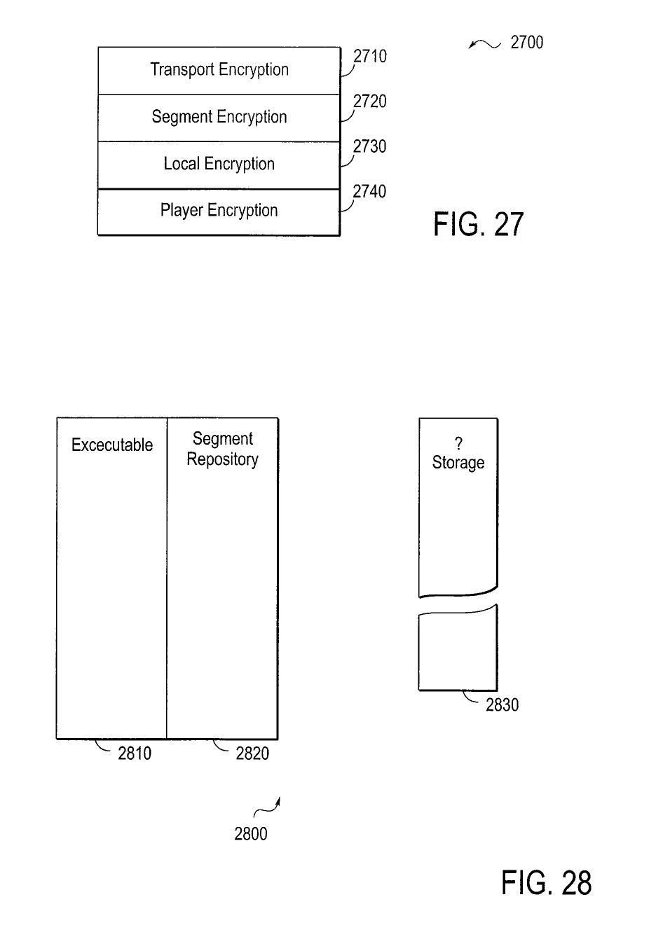

While a grid network may be used with either streamed or copied files, encryption of files can be important in either situation. FIG. 27 provides an illustration of an embodiment of encryption protection. Four levels of protection are potentially available, including transport, segment, local and player encryption. Encryption stack 2700 represents various levels or layers of encryption, some or all of which may be used for a given file.

Referring to each layer of encryption in turn, transport encryption 2710 represents encryption of a segment or packet at transport—such as through a digital certificate or digital signature of one form or another. Thus, each segment, in any form, may be encrypted when it is sent through a network. Segment encryption 2720 refers to encryption of various segments in a file, such as was referred to above with respect to FIGS. 14 and 15, for example. Thus, a segment can be encrypted as part of an integral whole file, making the segment difficult to use without the whole file.

Local encryption layer 2730 refers to encryption within a local repository. Thus, a segment may be stored in a local repository such as is referred to in FIG. 28, and storage in the repository may involve an encryption step over and above any other encryption. Player encryption layer 2740 refers to encryption options available from various media formats or players. Thus, a media player may automatically encrypt some files or all files of certain formats, with the player capable of decrypting the format, for example. Without an authenticated media player, it may be difficult to decrypt such a file. DRM, or digital rights management, implemented by the media player, may provide this layer, for example.

Segments, whether encrypted or not, must be stored somewhere during use. In some sense, a grid network of clients may function as a large storage network, storing files in parts throughout the network in a distributed manner. FIG. 28 provides an illustration of an embodiment of a client in an embodiment of a grid network. Each client 2800 may be expected to include an executable portion and a segment repository portion, and to make use of local storage. Executable portion 2810 may be the executable parts of code included in the client which implement its processes and perform its functions when executed by a processor or machine.

Segment repository 2820 may be a repository implemented by the client in local storage to store segments for use in playing a file and for exchange with other clients. Segment repository 2820, in one embodiment, is an encrypted data store which is intended to be accessible only by the client 2800 in a meaningful way. Thus, segments may be stored in segment repository 2820, but may be retrieved only by executable portion 2810 in a meaningful way. With most segments stored in segment repository 2820, this may make it difficult for someone to obtain unauthorized access to the segments, due to encryption of the entire repository. Moreover, a few segments may be stored in local storage 2830—apart from segment repository 2820. This may be referred to as memory caching—keeping some segments in a different memory (not necessarily a specific, fast memory). By keeping a few segments outside the repository, this means that simply copying the repository does not mean the entire file is copied—gaps will exist. Moreover, due to encryption of both the repository and the individual segments, the situation may resemble a puzzle where the shapes of the pieces are ill-defined and thus determinations of which puzzle pieces are available may be particularly challenging. Note, however, that memory caching need not be implemented in the system.

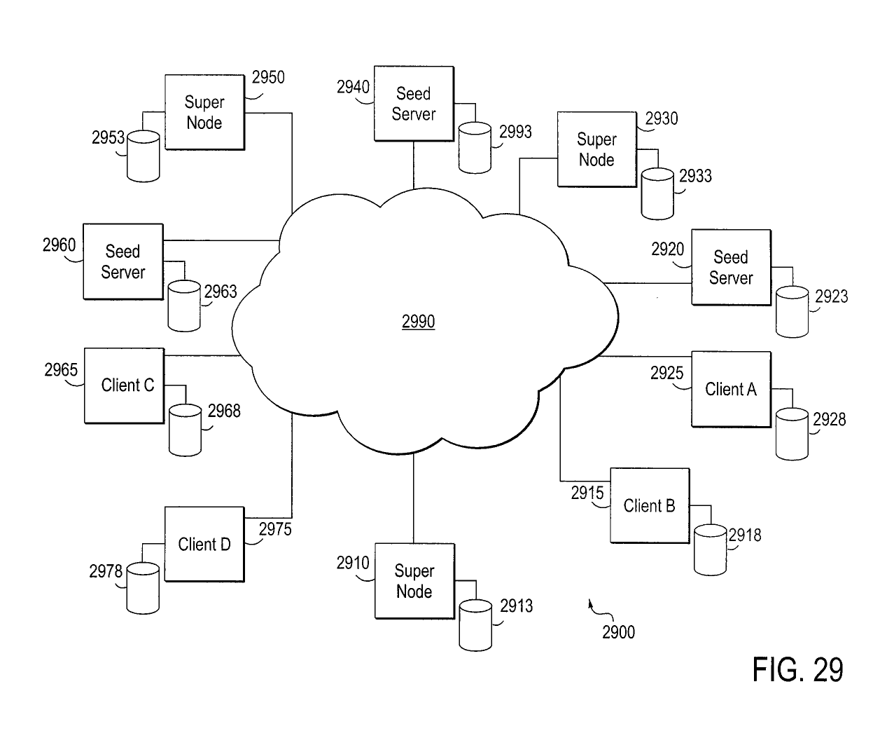

Consideration of an actual grid network embodiment may further illustrate some related aspects of the network and its clients. FIG. 29 provides an illustration of another embodiment of a grid network. Grid network 2900 is shown with a collection of super nodes, seed servers and clients. Network 2990 is a network such as the internet or another network which couples a variety of clients and servers.

Super node 2910 is a super node within network 2900 coupled to network 2990. Super node 2910 oversees some operations of the grid network 2900 and maintains some profile information for other parts of the grid network 2900. Thus, super node 2910 may maintain profile information about a variety of clients on the grid network, and may also maintain profile information about files on the grid network. The profile information for clients may indicate what data the client is storing and what type of connection the client has to the network 2990 and where (roughly) the client is located on the network. The profile information related to files may include information about which nodes have which segments of a file, file type, and number of segments for the file, for example. Super node 2910 is illustrated with local storage 2913 where these profiles and other administrative data may be stored. Also coupled to network 2990 are super node 2930 and super node 2950, each of which may provide similar services.

Seed server 2920 is also coupled to network 2990, along with the super nodes. Seed server 2920 may maintain segments of files in a local storage 2923. Moreover, seed server 2920 may seed the network with segments from a file by sending those segments to various clients. This seeding may be handled by sending out file segments proactively to create copies of a file in a distributed form in the network. Moreover, segments from a file may be supplied by a seed server responsive to a request from a client in some circumstances. However, supply by the seed server may be a disfavored option, due to efforts to have the network manage trading of segments and exchange of segments among clients. Also coupled to network 2990 are seed servers 2940 and 2960 with local storage 2943 and 2963.

Further coupled to network 2990 are clients 2915, 2925, 2965 and 2975. Client A (2925) is illustrated as having local storage 2928, whereas client B (2915) has local storage 2918, client C (2965) has local storage 2968 and client D (2975) has local storage 2978. Each client can be expected to have some segments from a number of files stored in local storage. When one client is seeking segments for a file, a super node may provide a list of clients storing relevant segments and the client can then request such segments.

Given the network topology illustrated, the clients may engage in peer-to-peer transfer of segments. To monitor the network, a super node 2910 may request periodic updates from the clients 2915, 2925, 2965 and 2975. This allows for maintenance of network status without requiring periodic pinging of the various clients. Additionally, seed servers such as server 2920 may seed the network in a peer-to-peer manner. Similarly, seed server 2920 may service urgent requests for segments from clients if necessary. Moreover, service of requests may be based on nearest-node determinations made in known ways using known services—thereby avoiding too much network congestion. Thus, a super node may provide to a client not only a list of which clients have which segments, but also an indication of how close each client is based on a particular client. If client A (2925) is close to client B (2915) on the network, and farther away from client C (2965) and client D (2975), then requests to client B (2915) may be favored. Similarly, if client A (2925) is close to seed server 2920 on the network, and far from seed server 2960, client A may be seeded by seed server 2920 rather than seed server 2960, for example.

Seed servers can potentially be provided anywhere—the seed server need not be physically close to a machine as long as it is logically close on a network (as measured in network hops). Thus, seed servers can be advantageously placed to achieve closeness to many clients. Additionally, most major networks operate on the principle that bandwidth within the network (from one location on a network to another location on the same network) is relatively cheap, but bandwidth outside the network (allowing a connection to or from a location on another network) is expensive. This is a result of how network interchange is handled and priced between major networks.

Thus, it can be advantageous to provide seed servers on many different networks. This allows for a seed server on a given network to service requests from clients on the same given network. Additionally, with a number of seed servers on each network, load-balancing and fault-tolerance can be implemented within the seed servers of each network. Thus, a grid network operator may place seed servers on a variety of networks, and then inform the network operators that the grid network bandwidth will be primarily or exclusively local to the various networks. This potentially allows for cost savings for the grid network operator and the underlying network operators. Interestingly, some physical locations allow for placement of servers on many different networks within a small physical space, such as where networks converge in San Jose, Calif. and in Seattle, Wash., for example.

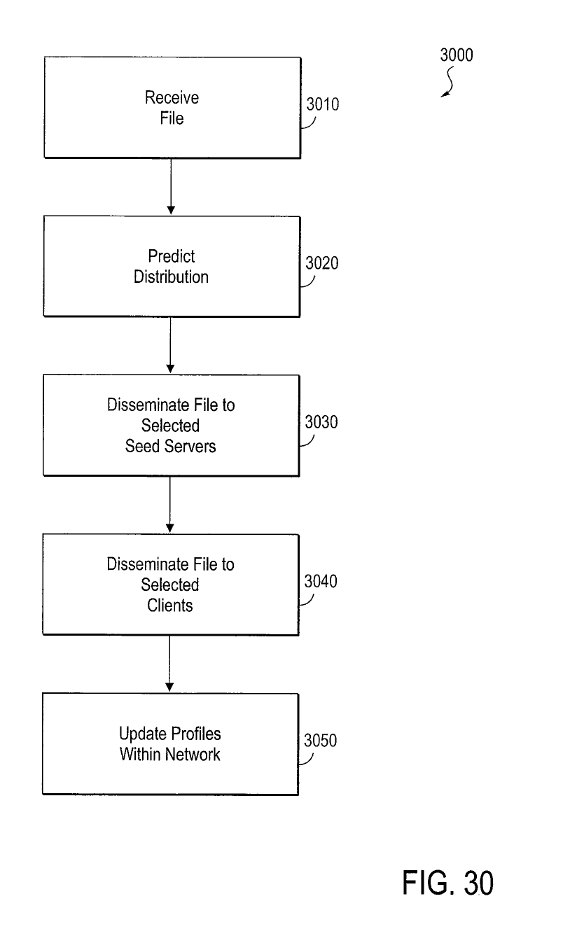

Seeding the grid network can provide excellent results when a file is shared initially. For example, a movie release to a grid network, without seeding, would involve a potential immediate spike in demand for the movie, with only the seed servers available for access to the file segments. FIG. 30 provides an illustration of an embodiment of a method of seeding a grid network. One may seed the network with copies of the file in advance of an expected spike (such as initial authorization to view the file). The process 3000 includes receiving a file, predicting distribution, disseminating the file to selected seed servers, disseminating the file to selected clients, and updating related profiles within the network.

When a file is received at module 3010, the file may be expected to be released or authorized for release soon thereafter. However, at module 3020, a prediction about distribution of the file may be made. This prediction may be based on templates for how distribution often occurs (e.g. science fiction movies may distribute in one known way, historical documentaries in another known way). Alternatively, this prediction may be based on what a media owner wants to occur (and is willing to pay for), for example. Thus, the prediction may include an indication of where the file should be disseminated for seeding or pre-release purposes.

At module 3030, the file is seeded to seed servers—it is copied to the servers identified in relation to the predicted distribution of module 3020. This may be based on geographical (actual or logical) location, bandwidth of servers, and other considerations. Similarly, at module 3040, the file is disseminated in whole or in part to selected clients. This may similarly be based on location within the network, for example. Moreover, this may be based on observed activity of the client, such as likelihood to watch the associated movie, bandwidth and connection properties, willingness to act as a seed client, mix of currently stored files, and other considerations. With the file seeded at both seed servers and at clients, profiles within the network (such as at super nodes) are updated. This allows for an actual release or authorization of a file to occur after seeding is observed to be complete. Note that due to the updating of such profiles, seeding may be monitored by simply reviewing profiles at super nodes, allowing for a snapshot of the seeding process which may be relatively up-to-date (due to continuous profile updates) without pinging each client for status, for example.

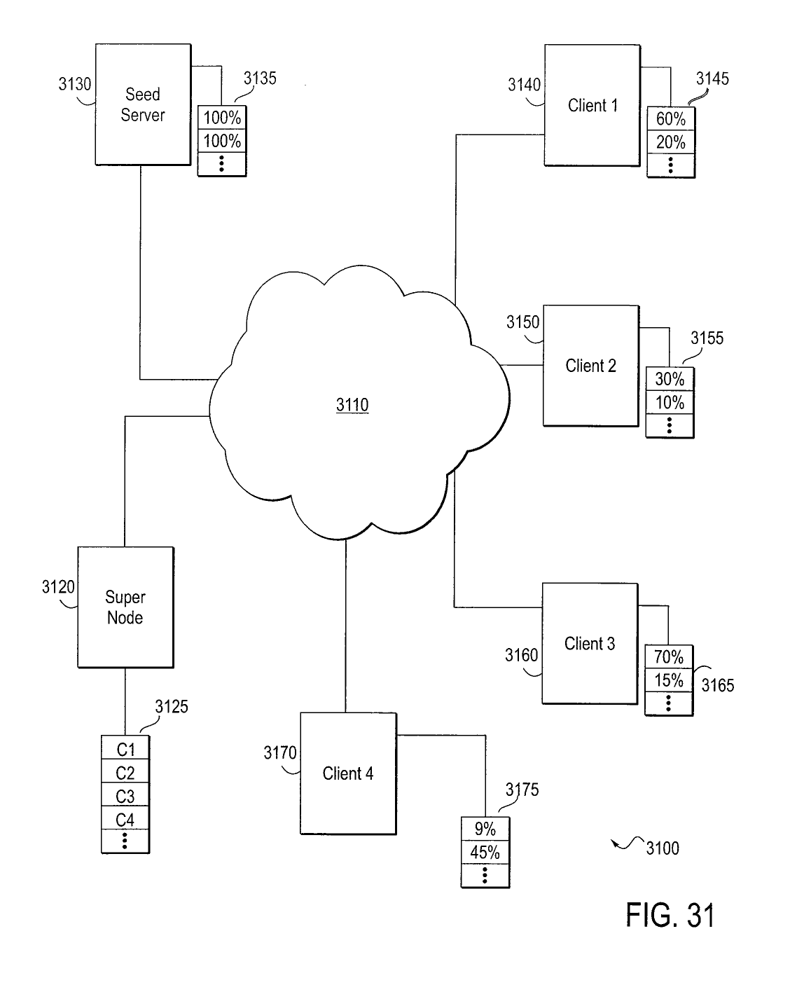

To further understand seeding, another example embodiment of a network may be helpful. FIG. 31 provides an illustration of an embodiment of a seeded grid network. System 3100 is a network of clients, seed server and super node which is seeded with two different movies. For example, it may be seeded with a copy of “This is Spinal Tap” and a copy of “Barney's Big Adventure” in this embodiment.

Network 3110 is a network such as the internet. Coupled to network 3110 is super node 3120, which provides oversight and management functions. Coupled to network 3110 is also seed server 3130, and its associated repository 3135. As illustrated, seed server 3130 has in its repository 3135 a copy of each movie—100% of the segments of each.

Client 1 (3140) is coupled to network 3110, and has a repository 3145. Repository 3145 has 6% of the segments of the first movie and 20% of the segments of the second movie. Client 2 (3150) is likewise coupled to network 3110, and has repository 3155 with 30% of a first movie and 10% of a second movie. Client 3 (3160) is coupled to network 3110, and has repository 3165 with 70% of the first movie and 15% of the second movie. Finally client 4 (3170) has repository 3175 and is coupled to network 3110. Repository 3175 includes 9% of a first movie and 45% of a second movie.

Repository 3125 of super node 3120 tracks information about what segments are at each client (1-4). In one embodiment, all clients report periodically on their status, including information on contents of their encrypted segment data store. In one embodiment, this occurs every 45 minutes, but other timer intervals may be used. While the percentages of each movie are shown for each client, which segments are present is not shown. The percentages of a file at each client may be stored for each client in repository 3125. Moreover, for illustrative purposes, it is assumed that each movie file is stored in the same order in each client repository (3145, 3155, 3165 and 3175). This is not necessarily the case, as random access storage may be implemented (and may be preferable). When sharing of segments for the two files occurs, client 3 may be an excellent source for “This is Spinal Tap” but a lousy “Barney's Big Adventure” source. The opposite may be true for client 4.

Note also that a full copy of “Barney's Big Adventure” is not necessarily present, whereas some duplication for “This is Spinal Tap” is necessary based on the percentages of each movie. However, segments may be duplicated throughout the network or may only appear at seed servers, depending on seeding preferences and usage of the network. Also, note that the figure provides an illustration of a snapshot of a network, and that transfer of segments may occur after such a snapshot, resulting in a different network status after a subsequent snapshot.

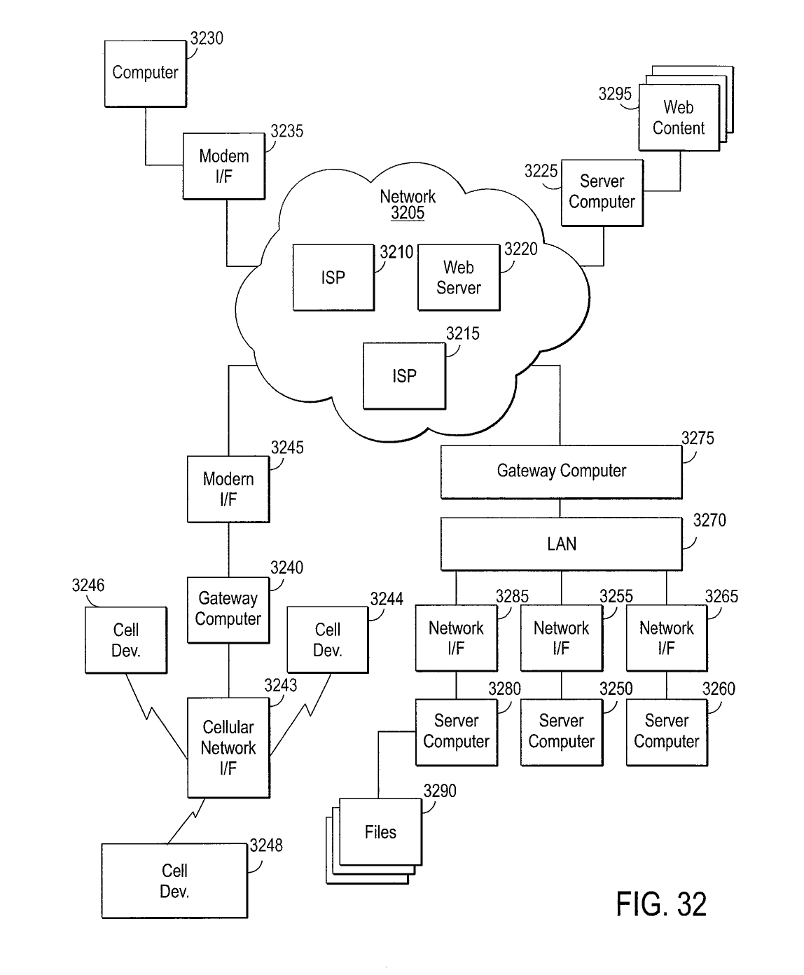

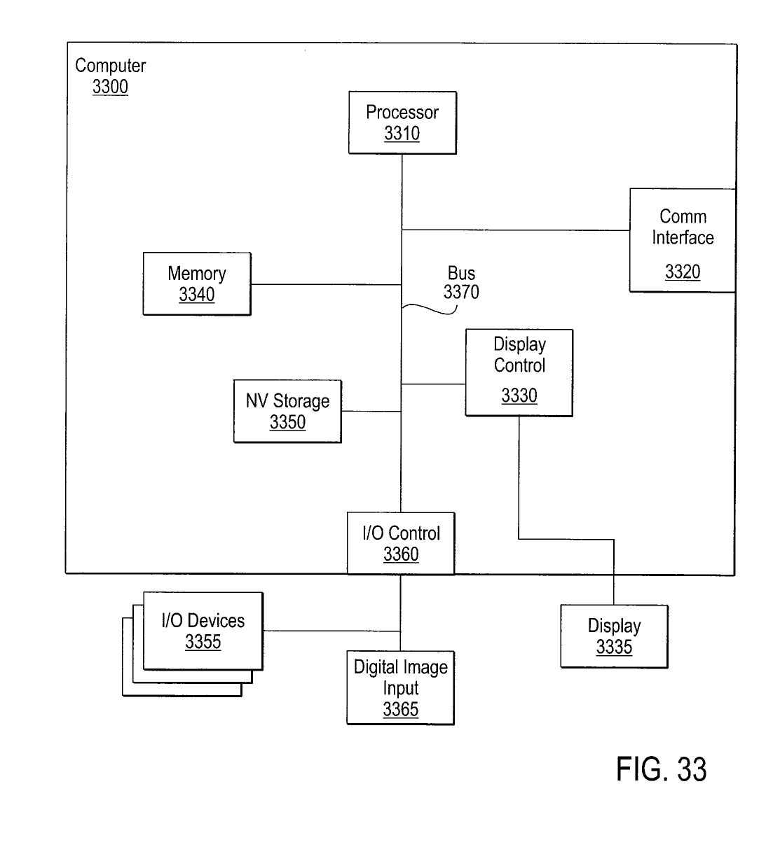

FIG. 32 provides an illustration of an embodiment of a network which may be used to implement a grid network. FIG. 33 provides an illustration of an embodiment of a machine which may be used in a grid network. The following description of FIGS. 32-33 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 32 shows several computer systems that are coupled together through a network 3205, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 3205 is typically provided by internet service providers (ISP), such as the ISPs 3210 and 3215. Users on client systems, such as client computer systems 3230, 3250, and 3260 obtain access to the internet through the internet service providers, such as ISPs 3210 and 3215. Access to the internet allows users of the client computer systems to exchange information, receive and send e-mails, and view documents, such as documents which have been prepared in the HTML format. These documents are often provided by web servers, such as web server 3220 which is considered to be “on” the internet. Often these web servers are provided by the ISPs, such as ISP 3210, although a computer system can be set up and connected to the internet without that system also being an ISP.

The web server 3220 is typically at least one computer system which operates as a server computer system and is configured to operate with the protocols of the world wide web and is coupled to the internet. Optionally, the web server 3220 can be part of an ISP which provides access to the internet for client systems. The web server 3220 is shown coupled to the server computer system 3225 which itself is coupled to web content 3295, which can be considered a form of a media database. While two computer systems 3220 and 3225 are shown in FIG. 32, the web server system 3220 and the server computer system 3225 can be one computer system having different software components providing the web server functionality and the server functionality provided by the server computer system 3225 which will be described further below.

Cellular network interface 3243 provides an interface between a cellular network and corresponding cellular devices 3244, 3246 and 3248 on one side, and network 3205 on the other side. Thus cellular devices 3244, 3246 and 3248, which may be personal devices including cellular telephones, two-way pagers, personal digital assistants or other similar devices, may connect with network 3205 and exchange information such as email, content, or HTTP-formatted data, for example. Cellular network interface 3243 is coupled to computer 3240, which communicates with network 3205 through modem interface 3245. Computer 3240 may be a personal computer, server computer or the like, and serves as a gateway. Thus, computer 3240 may be similar to client computers 3250 and 3260 or to gateway computer 3275, for example. Software or content may then be uploaded or downloaded through the connection provided by interface 3243, computer 3240 and modem 3245.

Client computer systems 3230, 3250, and 3260 can each, with the appropriate web browsing software, view HTML pages provided by the web server 3220. The ISP 3210 provides internet connectivity to the client computer system 3230 through the modem interface 3235 which can be considered part of the client computer system 3230. The client computer system can be a personal computer system, a network computer, a web tv system, or other such computer system.

Similarly, the ISP 3215 provides internet connectivity for client systems 3250 and 3260, although as shown in FIG. 32, the connections are not the same as for more directly connected computer systems. Client computer systems 3250 and 3260 are part of a LAN coupled through a gateway computer 3275. While FIG. 32 shows the interfaces 3235 and 3245 as generically as a “modem,” each of these interfaces can be an analog modem, isdn modem, cable modem, satellite transmission interface (e.g. “direct PC”), or other interfaces for coupling a computer system to other computer systems.

Client computer systems 3250 and 3260 are coupled to a LAN 3270 through network interfaces 3255 and 3265, which can be ethernet network or other network interfaces. The LAN 3270 is also coupled to a gateway computer system 3275 which can provide firewall and other internet related services for the local area network. This gateway computer system 3275 is coupled to the ISP 3215 to provide internet connectivity to the client computer systems 3250 and 3260. The gateway computer system 3275 can be a conventional server computer system. Also, the web server system 3220 can be a conventional server computer system.

Alternatively, a server computer system 3280 can be directly coupled to the LAN 3270 through a network interface 3285 to provide files 3290 and other services to the clients 3250, 3260, without the need to connect to the internet through the gateway system 3275. FIG. 33 shows one example of a personal device that can be used as a cellular telephone (3244, 3246 or 3248) or similar personal device. Such a device can be used to perform many functions depending on implementation, such as telephone communications, two-way pager communications, personal organizing, or similar functions. The system 3300 of FIG. 33 may also be used to implement other devices such as a personal computer, network computer, or other similar systems. The computer system 3300 interfaces to external systems through the communications interface 3320. In a cellular telephone, this interface is typically a radio interface for communication with a cellular network, and may also include some form of cabled interface for use with an immediately available personal computer. In a two-way pager, the communications interface 3320 is typically a radio interface for communication with a data transmission network, but may similarly include a cabled or cradled interface as well. In a personal digital assistant, communications interface 3320 typically includes a cradled or cabled interface, and may also include some form of radio interface such as a Bluetooth or 802.11 interface, or a cellular radio interface for example.

The computer system 3300 includes a processor 3310, which can be a conventional microprocessor such as an Intel pentium microprocessor or Motorola power PC microprocessor, a Texas Instruments digital signal processor, or some combination of the two types or processors. Memory 3340 is coupled to the processor 3310 by a bus 3370. Memory 3340 can be dynamic random access memory (dram) and can also include static ram (sram), or may include FLASH EEPROM, too. The bus 3370 couples the processor 3310 to the memory 3340, also to non-volatile storage 3350, to display controller 3330, and to the input/output (I/O) controller 3360. Note that the display controller 3330 and I/O controller 3360 may be integrated together, and the display may also provide input.

The display controller 3330 controls in the conventional manner a display on a display device 3335 which typically is a liquid crystal display (LCD) or similar flat-panel, small form factor display. The input/output devices 3355 can include a keyboard, or stylus and touch-screen, and may sometimes be extended to include disk drives, printers, a scanner, and other input and output devices, including a mouse or other pointing device. The display controller 3330 and the I/O controller 3360 can be implemented with conventional well known technology. A digital image input device 3365 can be a digital camera which is coupled to an I/O controller 3360 in order to allow images from the digital camera to be input into the device 3300.

The non-volatile storage 3350 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 3300. Rather, a mass storage device on another computer is typically used in conjunction with the more limited storage of the device 3300. Some of this data is often written, by a direct memory access process, into memory 3340 during execution of software in the device 3300. One of skill in the art will immediately recognize that the terms “machine-readable medium” or “computer-readable medium” includes any type of storage device that is accessible by the processor 3310 and also encompasses a carrier wave that encodes a data signal.

The device 3300 is one example of many possible devices which have different architectures. For example, devices based on an Intel microprocessor often have multiple buses, one of which can be an input/output (I/O) bus for the peripherals and one that directly connects the processor 3310 and the memory 3340 (often referred to as a memory bus). The buses are connected together through bridge components that perform any necessary translation due to differing bus protocols.

In addition, the device 3300 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm(g operating system and its associated file management system. The file management system is typically stored in the non-volatile storage 3350 and causes the processor 3310 to execute the various acts required by the operating system to input and output data and to store data in memory, including storing files on the non-volatile storage 3350. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 3300 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

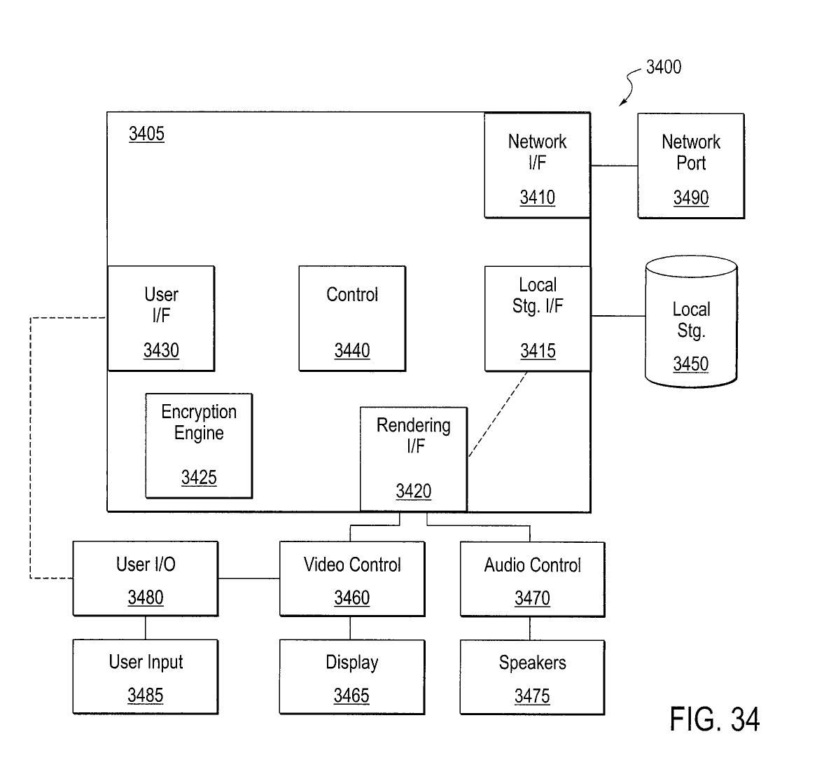

While various different implementations of components of the network and associated machines can be used, an example implementation may prove helpful. FIG. 34 provides an illustration of an embodiment of a client in an embodiment of a network. System 3400 includes client 3405, along with user I/O, video and audio control, local storage and a network interface.

Client 3405 includes a control module 3440, a network interface 3410, a local storage interface 3415, a rendering interface 3420, an encryption engine 3425 and a user interface 3430. Network interface 3410 operates with network port 3490 to couple with a grid network. Local storage interface 3415 stores and retrieves data of local storage (repository) 3450.

Rendering interface 3420 renders segments of files into a useful format, such as may be displayed, played (sound) or stored. Rendering interface 3420 interacts with video controller 3460 and audio controller 3470 to activate display 3465 and speakers 3475, for example. Moreover, rendering interface 3420 may cause rendered segments to be written locally through local storage interface 3415. Encryption engine 3425 decrypts (and if necessary, encrypts) segments and related data. User interface 3430 interacts with user I/O controller 3480. User I/O controller 3480 may interact with user input device(s) 3485, and with video (3460) and audio (3470) controllers, for example. Control module 3440 controls the other components of client 3405.

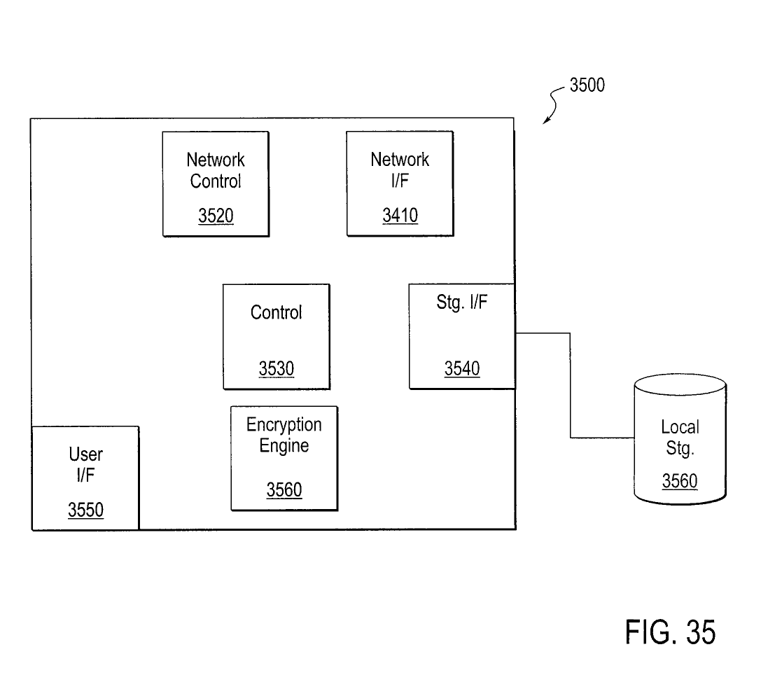

Similarly, various server implementations may be used, and an example implementation may be useful. FIG. 35 provides an illustration of an embodiment of a server in an embodiment of a network. Server 3500 includes a network interface, network control module, storage interface, encryption engine, user interface and control module. Network interface 3510 interfaces with a grid network and any underlying networks. Network control module 3520 provides control functions and may provide control signals for the grid network. Such control signals and functions may issue job tickets, cut off access for malicious or non-function clients, or direct clients to assist other clients, for example.

Storage interface 3540 interacts with local storage 3560, storing and retrieving information about the network and clients therein. Encryption engine 3560 encrypts and decrypts data, such as when verifying authenticity of a packet from a client, for example. User interface 3550 allows for user interaction with server 3500, such as to allow for inspection of statistics or override of configuration, for example. Control module 3530 controls the other components of server 3500 and facilitates communication therebetween.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A system, comprising:
a server having:
a network interface,
a local repository interface,
a control module,
a local repository;
wherein the server is to interact with clients of a grid network;
and
receive status updates from clients of the grid network.

2. The system of claim 1, wherein the server is further to:
direct clients of the grid network to contact other clients of the grid network.

3. The system of claim 1, wherein
the server is further to:
issue job tickets to clients of the grid network responsive to client requests.

4. The system of claim 3, wherein
the server is further to:
verify authenticity of job ticket information submitted by clients of the grid network.

5. The system of claim 4, wherein
the server is further to:
provide lists of clients of the grid network with segments of a file.

6. The system of claim 5, wherein
the server is further to:
maintain status information related to clients of the grid network.

7. The system of claim 1, wherein
the server is further to:
maintain statistical information related to functioning of the grid network.

8. The system of claim 1, further comprising:
means for encrypting data; and
means for decrypting data.

8. The system of claim 1, further comprising:
an encryption engine.

9. The system of claim 1, wherein:
the server is implemented as a set of code modules, the code modules embodied in a machine-readable medium as a set of instructions, the instructions, when executed by a processor, implementing the server.

10. A method, comprising:
receiving status updates from clients of a grid network;
directing clients of the grid network to contact other clients of the grid network;
issuing job tickets to clients of the grid network responsive to client requests;
verifying authenticity of job ticket information submitted by clients of the grid network;
providing lists of clients of the grid network with segments of a file;
maintaining status information related to clients of the grid network; and
maintaining statistical information related to functioning of the grid network.

11. A method, comprising:
receiving a request to seed a data file;
selecting clients of a grid network to receive the data file based on network connectivity; and
sending segments of the data file to selected clients of the grid network responsive to the request to seed the data file.

12. The method of claim 11, wherein:
the segments of the data file are not authorized for rendering at the time of sending the segments of the data file.

13. The method of claim 11, wherein:
the segments of the data file are authorized for rendering at the time of sending the segments of the data file.

14. The method of claim 11, wherein:
a seed server performs sending segments of the data file.

15. The method of claim 14, wherein:
a super node performs selecting clients of the grid network.

16. The method of claim 11, further comprising:
exchanging segments of the data file between clients of the grid network.

17. The method of claim 14, wherein:
the selected clients and the seed server collectively are all connected to the same underlying service provider network.

18. The method of claim 11, wherein:
a first seed server and a second seed server collectively perform sending segments of the data file;
the selected clients include a first set of clients and a second set of clients;
the first seed server and the first set of clients collectively are all connected to the same first underlying service provider network;
the second seed server and the second set of clients collectively are all connected to the same second underlying service provider network; and
the first seed server sends segments to the first set of clients and the second seed server sends segments to the second set of clients.

19. The method of claim 11, wherein:
the segments are segments of a movie data file.

20. The method of claim 11, wherein:
the segments are segments of a database data file.

21. The method of claim 11, wherein:
the method is embodied in a set of instructions embodied in a machine-readable medium, the set of instructions, when executed by a processor, causing the processor to implement the method.
